(19) United States
(12) Patent Application Publication
(10) Pub. No.: US 2011/0266717 A1
(43) Pub. Date: Nov. 3, 2011

(54) Microwave-Assisted Setting of Shaped Ceramic/Foam Bodies

(75) Inventors: Benjamin Nehls, Ludwigshafen (DE); Bernhard Schmied, Frankenthal (DE); Ulrike Mann, Mannheim (DE); Klaus Hahn, Kirchheim (DE); Sabine Fuchs, Mannheim (DE); Tatiana Ulanova, Ludwigshafen (DE); Timothy Francis, Mannheim (DE); Petra Wieland, Worms (DE); Klaus-Martin Baumgaertner, Fraenkisch-Crumbach (DE); Horst Muegge, Weinheim (DE)

(73) Assignee: BASF SE

(21) Appl. No.: 13/142,628

(22) PCT Filed: Dec. 14, 2009
(86) PCT No.: PCT/EP09/67079

§ 371 Date: Jun. 29, 2011

(30) Foreign Application Priority Data
Dec. 30, 2008 (EP) 08173048.3

(51) Int. Cl. B29C 35/08; B29C 67/20

(52) U.S. Cl. 264/413; 425/174.4

(57) ABSTRACT

The invention relates to a method for the production of shaped foam bodies, comprising: provision of a composition having foam particles and binder; introduction of the composition into a space which is bounded on at least one side by a pressing surface; and exertion of pressure onto the composition by means of the pressing surface. The method further comprises irradiation of microwaves through the pressing surface into the composition, while pressure is being exerted onto the composition. The invention furthermore relates to a device for carrying out the method according to the invention, having: at least one pressing surface and a counterbearing surface lying opposite, between which a space extends which is adapted to receive a composition of foam particles and binder. The pressing surface and counterbearing surface adjoin the space directly. The device further comprises at least one stiff layer which locally or entirely is essentially transparent for microwaves and has a surface facing toward the space, which is connected to the pressing surface in such a way as to transmit force. The device also comprises a microwave radiator unit which is arranged on a side of the stiff layer remote from the space and is aligned relative to the space in order to irradiate microwaves into the space through the stiff layer. Lastly, the invention relates to a microwave radiator unit for the heat treatment of foam compositions. The microwave radiator unit comprises a multiplicity of microwave antennas which are arranged in a plane array and at least two of which are connected through a distributor device to a common microwave signal source, which feeds the at least two antennas.

The invention relates to a method and to devices for the production of shaped foam bodies from foam particles.

Shaped foam bodies made of foam particles, i.e. particle foams, are produced for example by connecting individual foam particles by means of a binder. To this end they are conventionally compressed, the individual foam particles being connected together by solidification of the binder. Particularly for the production of flame-retardant or heat- and fire-resistant foam bodies, a method employing the pre-foamed particle is used, the heat and fire resistance depending directly on the choice of binder. Besides the selection of the binder, the operating parameters of the production method crucially influence the strength and heat resistance of the shaped foam body being produced.

The temperature prevailing during the production process is regarded as one of the parameters, numerous approaches being known for heating a material. Basically, on the one hand a contact or infrared radiation method may be used for heating, either with a heat source being applied directly to the material to be heated, for example in the form of a hot plate, or by directing infrared radiation onto the surface of the material to be heated. Particularly in the case of large material thicknesses or low thermal transfer, this leads to strong temperature gradients so that essentially only the surface of the material is heated and internal sections are heated merely by thermal diffusion. In order to achieve an approximately homogeneous temperature distribution, the heating of particularly thick layers requires a long waiting time in order to allow sufficient distribution of the heat. In fact, conventional methods for producing thick layers have a low setting speed. Since, for the inventive production of foam bodies, maximally homogeneous temperature conditions should exist inside the body to be processed, these two approaches which essentially heat only the material surface are not suitable for all methods.

Microwaves, which have a certain penetration depth and therefore reduce the temperature gradient problem, are also generally used for heating materials. Besides numerous applications such as are widely known from the field of food-processing, microwaves are also used for heating in other applications.

Some applications relate to the field of producing relatively thin layers whose thickness represents only a small fraction of the wavelength of microwaves, which in turn dictates the penetration depth. For this reason, in these fields the technique is not based on the action at depth of the microwave irradiation, but merely on microwave radiation as a possibility for heating, for example as an alternative to or in combination with heating methods which work on the surface.

Examples which may be mentioned here heatable steel strips, such as are used for example in DE 197 18 772 A1. In fundamental contrast to the invention, however, in this case solid thin layers in the form of laminate structures of a wood material board are preheated to ≧85° C. by means of microwave energy, while the field of the invention relates to the field of shaped foam bodies which have a much larger thickness, and which must not be heated to such high temperatures. The method criteria applicable to the field of shaped foam bodies, i.e. large layer thickness in relation to the length of the microwave radiation, lower temperature and a working pressure on the material which is orders of magnitude less, make it impossible to adapt those for such lamination methods for wood material boards to the field of the present invention.

Document U.S. Pat. No. 5,018,642, in which microwaves are used to heat wood/resin structures such as plywood boards, relates to a field of application which is similar to the lamination of wood material boards. Here again, the homogeneity of the heating is as unimportant as the penetration depth, owing to the small layer thickness. As in DE 196 27 024, the pressure values used in U.S. Pat. No. 5,018,642 are also several orders of magnitude greater than in the method according to the invention for producing shaped foam bodies. Similarly, DE 196 27 024 A1 presents a method for gluing veneer panels together to form veneer laminate boards, in which microwaves are used for intermediate heating during the layer gluing process.

WO 2008/043700 A1 proposes the processing of foam particles to form shaped foam bodies by means of a method which comprises heating by means of microwaves. It describes the production of an endless foam panel by compressing it into the gap between two metal strips. In order to heat it, microwave radiation is irradiated laterally into the gap between the metal strips. On the one hand, owing to the properties of the metal strips for microwave radiation, this leads to strong reflections that impede central microwave heating, and on the other hand with conventional layer widths, which represent a multiple of the wavelength (about 15 cm), the microwave absorption along the width of the layer to be heated also impedes heating of the layer in central regions between the peripheral regions.

In summary, the approaches known from the prior art for the use of microwaves generate a strong temperature gradient, which is unimportant for thin layers owing to their small thickness but in the case of thick layers causes central regions in particular to be heated much less than outer regions. This inhomogeneous temperature distribution in thick layers leads to very inhomogeneous material properties of the layer being produced, and in particular to long setting times for the central layers or to undesirably high temperatures at the peripheral regions, where the microwave radiation is introduced. Furthermore, none of the known methods takes into account the effects of the microwave heating directly at the site of compression of the layer to be produced.

It is therefore an object of the invention to provide at least one production method and at least one device used therefor, by which foam panels can be produced rapidly with high quality and low production costs.

This object is achieved by the method according to the invention of independent claim 1 and by the devices of the independent claims.

The underlying principle of the invention, when producing shaped foam bodies, is to apply a pressure to the initial composition in combination with microwave irradiation. The exerted pressure and the microwave irradiation preferably affect an overlapping section of the composition or the same space, to which pressure/microwaves are applied. The pressure and microwave irradiation preferably take place simultaneously onto the same space which contains the composition. According to the invention, the microwaves are irradiated through the surface which exerts the pressure on the initial composition. The pressure is exerted by a pressing surface or counterbearing surface, while the microwaves are irradiated through it so as to heat the initial composition, especially where it is compacted. Pressure may be exerted through surfaces actively from the outside by volume reduction of the space, or may be generated by restoring forces of the composition (for example due to prior compression). Surfaces which act as a counterbearing may furthermore exert pressure.

Because the pressure action and the heat radiation input come from the same surface, even in the case of large surfaces both the pressure and the heating can be provided uniformly distributed over the surface. This also makes it possible to produce shaped foam bodies with large volumes, in principle with arbitrary widths and lengths, while heating them homogeneously. The formation of the shaped body is directly linked with the temperature. The mechanical properties of the shaped body are therefore also rendered homogeneous by the method.

According to the invention, all or at least some of the pressing surface is therefore used as a window for introducing microwaves which generate heat, so that the access window to the initial composition provided by the pressing surface can be used for direct application of the desired pressure and temperature conditions. Particularly in contrast to laterally irradiated microwaves, this makes it possible to produce shaped foam bodies in essentially all conventional design sizes, without entailing the risk that peripheral regions will be too brittle owing to overheating and that an inner region will not be set fully. In particular, use of the pressing surface to transmit the microwaves as well offers a very large area for introduction of the microwave radiation, so that the production is significantly accelerated, in contrast for example to foams irradiated from the edge in which the microwaves penetrate only to a highly attenuated extent into the interior of the foam body being produced.

According to the invention, the composition is compressed while the composition is irradiated with microwaves. The compression and the radiation direction of the microwaves have essentially the same direction, the compression preventing the composition from expanding in the direction along which the microwaves enter the composition. The compression is generated either actively from the outside by reducing the volume of the composition, or passively by feeding the composition between surfaces that define a volume which is less than the volume of the composition, which the composition would occupy without compression. Particularly for layer structures, this gives a high homogeneity of the temperature distribution and a high homogeneity of the material strength of the resulting material, with substantially reduced plastic and elastic anisotropy of the resulting layer. This essentially results in a homogeneous, isotropic strength which is obtained by uniform sintering; owing to the compression during sintering, no deformation which could interfere with the sintering process takes place.

Improved properties are furthermore obtained for the shaped foam body being produced owing to the simultaneous exertion of pressure and irradiation of microwaves. The heating which results from the microwaves leads to modifications of the initial composition within the space in which it is contained, for example expansion due to thermal expansion, due to vapor pressure and due to emerging gas. Because pressure is exerted simultaneously, the irradiation of microwaves does not therefore lead to plastic modifications or shape changes of the foam body being produced, since the pressure opposes expansion of the foam body being produced which would occur owing to the heating in the absence of compression. In particular, this avoids the foam body being produced expanding in the direction from which the microwave irradiation originates. In particular, anisotropic material properties are therefore avoided within the shaped body being generated. In particular, it prevents the composition swelling out from side to side during the microwave irradiation while the composition is bounded by an upper surface and a lower surface, both of which are perpendicular to the side surface.

The use of microwaves for heating allows the heating to have a homogeneous distribution so as to prevent, particularly at high temperatures, for example above 60 or 70° C., regions simultaneously being created in which the temperature is at 100° C. and a great amount of vapor is therefore formed. Particularly when the material of the foam particles is heat-sensitive, for example in the case of foamed polystyrene, or when the material of the binder is heat-sensitive or if both materials are heat-sensitive, it is important to comply with a limit temperature without at the same time insufficiently heating some regions of the body being produced. Owing to the homogeneous irradiation, high temperatures can therefore be achieved while simultaneously avoiding areas which generate vapor; if vapor is formed, the exit flow of the vapor will undesirably deform the shaped foam body being produced or detrimentally affect its setting. In particular, avoiding the formation of vapor can prevent any essential heat losses due to evaporation. Furthermore, the heat input by microwave radiation can be controlled almost without delay and precisely, particularly since essentially only the shaped foam body being produced is heated and no metal bodies required for the heating (such as heated steel plates) are heated. Above all when process steps such as maintenance or refilling require cold tool surfaces, it important to have rapid cooling or little heating of the surfaces. This is achieved by microwave radiation since the tool per se is heated little or only indirectly, so that the corresponding surfaces which come into contact with the composition are heated only slightly and cool rapidly again to a temperature which does not cause any burning on the skin if they are touched.

In particular, the method according to the invention and the devices according to the invention are suitable for producing fire-resistant foam bodies in which a nonflammable binder is used, preferably a binder which can be excited by microwave radiation. Water-based binders are such binders, as are silicate-based binders such as silicates, for example sodium and potassium silicates.

The composition for the binder, which is preferably formed as a coating of the foam particles, comprises according to a preferred embodiment:

a) from 20 to 70 wt. %, in particular from 30 to 50 wt. % of a clay mineral
b) from 20 to 70 wt. %, in particular from 30 to 50 wt. % of an alkali metal silicate
c) from 1 to 30 wt. %, in particular from 5 to 20 wt. % of a film-forming polymer.

Another preferred composition comprises:

a) from 30 to 50 wt. %, in particular from 35 to 45 wt. % of a clay mineral
b) from 30 to 50 wt. %, in particular from 35 to 45 wt. % of an alkali metal silicate
c) from 5 to 20 wt. %, in particular from 7 to 15 wt. % of a film-forming polymer
d) from 5 to 40 wt. %, in particular from 10 to 30 wt. % of an infrared-absorbing pigment or a microwave-absorbing substance.

According to another aspect of the invention, the composition comprises:
a) from 20 to 70 wt. %, in particular from 35 to 60 wt. % of a ceramic material
b) from 0 to 70 wt. %, preferably more than 1 wt. % and in particular from 20 to 50 wt. % of an alkali metal silicate
c) from 1 to 60 wt. %, in particular 20 to 40 wt. % of nanoscale SiO₂ particles
d) from 1 to 30 wt. %, in particular from 5 to 20 wt. % of a film-forming polymer
e) from 0 to 40 wt. %, preferably more than 1%, in particular from 10 to 30 wt. % of an infrared-absorbing pigment or a microwave-absorbing substance.

The quantitative data above in each case refer to solid material in expressed in terms of the solid material of the binder. The components a) to c) or a) to d) preferably add up to 100 wt. %.

The weight ratio of clay mineral to alkali metal silicate in the binder preferably lies in the range of from 1:2 to 2:1.

Suitable clay minerals are, in particular, minerals which comprise at least one of the following minerals:
Allophone (Al₂O₃.y SiO₂.z H₂O, with x:y ca. 1:1 or Al₂O₃.(SiO₂)_{1.3-2}.(H₂O)_{2.5-3})
kaolinite (Al₄[(OH)₈|Si₄O₁₀])
halloysite (Al₄[(OH)₈|Si₄O₁₀].2 H₂O)
montmorillonite (smectite) ((Al,Mg,Fe)₂[(OH₂|(Si,Al)₄O₁₀].Na_{0,33}(H₂O)₄)
vermiculite (Mg₂(Al,Fe,Mg)[(OH₂|(Si,Al)₄O₁₀].Mg_{0,35}(H₂O)₄)

Mixtures of these minerals are furthermore suitable. Kaolin is particularly preferably used as a constituent of the binder.

As ceramic forming clay minerals (as component of the composition), in particular for providing the ceramic material, suitable materials are: minerals or mixtures comprising at least one of allophone, Al₂[SiO₅]&O₃.n H₂O; kaolinite, Al₄[(OH)₈|Si₄O₁₀]; halloysite, Al₄[(OH)₈|Si₄O₁₀].2 H₂O; montmorillonite (Smectit), (Al,Mg,Fe)₂[(OH₂|(Si,Al)₄O₁₀]. Na_{0,33}(H₂O)₄; and vermiculite, Mg₂(Al,Fe,Mg)[(OH₂|(Si,Al)₄O₁₀].Mg(H₂O)₄.

Most preferably, kaolinite is used as a component of the composition, preferably as binder. Further, compositions comprising a ceramic forming calcium silicate are suited, preferably wollastonite.

Besides the clay minerals, other minerals may also be added to the binder provided as a coating of the foam particles, for example cements, aluminum oxides, vermiculite or perlite. These may be introduced into the coating composition in the form of aqueous suspensions or dispersions. Cements may also be applied onto the foam particles by “powdering”. The water required in order to bind the cement may be supplied by water vapor during the sintering.

As an alkali metal silicate, it is preferable to use a water-soluble alkali metal silicate having the composition M₂O(SiO₂)ₙ with M=sodium or potassium and n=1 to 4 or mixtures thereof as a constituent of the binder.

In general, the binder provides a polymer film which has one or more glass transition temperatures in the range of from −60° to +100° C. Fillers may be embedded in the binder, as may material which provides the foam particles. The glass transition temperatures of the dried polymer film preferably lie in the range of from −30° to +80° C., particularly preferably in the range of from −10° to +60° C. The glass transition temperature may be determined by means of differential scanning calorimetry (DSC) according to ISO 11357-2 at a heating rate of 20° C./min. The molecular weight of the polymer film, determined according to gel permeation chromatography (GPC), is preferably less than 400,000 g/mol. In order to coat the foam particles with binder, conventional methods such as spraying, immersion or wetting the foam particles with the aqueous polymer dispersion may be used in conventional mixers, spraying devices, immersion devices or drum apparatus.

Suitable for the binder, which may be provided as a coating of the particles, are for example polymers based on monomers such as vinyl aromatic monomers, such as α-methylstyrene, p-methylstyrene, ethylstyrene, tert.-butylstyrene, vinylstyrene, vinyltoluene, 1,2-diphenylethylene, 1,1-diphenylethylene, alkenes such as ethylene or propylene, dienes such as 1,3-butadiene, 1,3-pentadiene, 1,3-hexadiene, 2,3-dimethylbutadiene, isoprene, piperylene or isoprene, α,β-unsaturated carboxylic acids such as acrylic acid and methacrylic acid, their esters, in particular alkyl esters such as C₁₋₁₀ alkyl esters of acrylic acid, in particular the butyl ester, preferably n-butyl acrylate, and the C₁₋₁₀ alkyl esters of methacrylic acid, in particular methyl methacrylate (MMA), or carboxylic acid amides, for example acrylamide and methacrylamide.

The polymers may optionally contain from 1 to 5 wt. % of comonomers, such as (meth)acrylonitrile, (meth)acrylamide, ureido(meth)acrylate, 2-hydroxyethyl(meth)acrylate, 3-hydroxy-propyl(meth)acrylate, acrylamide propanesulfonic acid, methylolacrylamide or the sodium salt of vinylsulfonic acid. The binder preferably comprises polymers of one or more of the monomers styrene, butadiene, acrylic acid, methacrylic acid, C₁₋₄ alkyl acrylates, C₁₋₄ alkyl methacrylates, acrylamide, methacrylamide and methylolacrylamide.

Inter alia, the binder may furthermore contain acrylate resins, which according to the invention are applied onto the foam particles as aqueous polymer dispersions, optionally also with hydraulic binders based on cement, lime cement or gypsum. Polymer dispersions suitable as binders are for example obtainable by radical emulsion polymerization of ethylenically unsaturated monomers, such as styrene, acrylates or methacrylates, as described in WO 00/50480.

Particularly preferred as binders are pure acrylates or styrene acrylates, which comprise or are made from the monomers styrene, n-butylacrylate, methyl methacrylate (MMA), methacrylic acid, acrylamide or methylolacrylamide.

Preparation of the Binder as a Polymer Dispersion is Carried Out in a Manner Known Per Se, for instance by emulsion, suspension or dispersion polymerization, preferably in the aqueous phase. The polymer may also be prepared by a solution or mass polymerization, optionally comminution and subsequently dispersing the polymer particles in water in the conventional way. The initiators, emulsifiers or suspension aids, regulators and other auxiliaries usual for the polymerization method in question are also employed; the polymerization is carried out continuously or discontinuously in conventional reactors with the usual temperatures and pressures for the method in question.

The binder, and in particular the foam particles, may also contain additives such as inorganic fillers, such as pigments and flameproofing agents. The proportion of additive depends on its nature and the desired effect; for inorganic fillers which form the particles, it is generally from 10 to 99 wt. %, preferably from 20 to 98 wt. %, expressed in terms of the polymer coating containing additives.

The binder preferably contains water-binding substances, for example waterglass. This leads to better or more rapid film formation by the polymer dispersion, and therefore more rapid setting of the shaped foam body.

The binders provided as coatings according to the invention are compositions of alkali metal silicates, clay minerals, a film-forming polymer (preferably an Acronal dispersion) and further additives. Inter alia melamine compounds, phosphorus compounds, intumescent compositions etc. are suitable for this.

Preferably, the composition contains nanoscale SiO₂ particles in form of aqueous, colloidal SiO₂ particles as dispersion.

More preferably, the composition contains dispersed aqueous, colloidal SiO₂ particles stabilized by onium ions, in particular ammonium ions, (eg. NH₄⁺) as counter ion. The stabilization can also be provided by alkali ions, alkaline earth ions or both. The average particle diameter of a SiO₂-particle is in the range of 1 to 100 nm, preferably in the range of 10 to 50 nm. The specific surface of the SiO₂ particles is commonly in the range of 10 to 3000 m²/g, preferably in the range of 30 bis 1000 m²/g. The solids content of SiO₂ particle dispersion of suitably, commonly available dispersions depends on the particle size and is in the range of 10 to 60 wt. %, preferably in the range of 30 to 50 wt. %. Aqueous, colloidal SiO₂ particle dispersions can be provided by neutralization of diluted sodium silicate using acid, ion exchange, hydrolyses of silicon compounds, dispersion of pyrogene silicate or oder gel precipation.

The further additives are preferably materials to reduce the thermal conductivity, an infrared-absorbing pigment (IR absorber) such as carbon black, coke, aluminum, graphite or titanium dioxide used in amounts of from 5 to 40 wt. %, particularly in amounts of from 10 to 30 wt. %, expressed in terms of the solid material of the binder. The particle size of the IR-absorbing pigments generally lies in the range of from 0.1 to 100 μm, particularly in the range of from 0.5 to 10 μm. Carbon black is preferably used with an average primary particle size in the range of from 10 to 300 nm, particularly in the range of from 30 to 200 nm. The BET surface preferably lies in the range of from 10 to 120 m²/g. As graphite, it is preferable to use graphite with an average particle size in the range of from 1 to 50 μm.

The binder provided as a coating composition may furthermore contain flameproofing agents such as exfoliated graphite, borates, in particular zinc perborate, melamine compounds or phosphorus compounds or intumescent compositions, which expand, swell or foam under the effect of elevated temperatures, generally above 80 to 100° C., and thereby form an insulating and heat-resistant foam which protects the underlying heat-insulating foam particles from the effect of fire and heat.

The composition (as well as the additive(s)) contain components absorbing microwave radiation. The main absorption effect is provided by the water. In addition, the additives of the composition (e.g. additives of the binder) provide microwave absorption. Such components comprised by the composition (or by the additives or by the binder) suited for enhancing microwave absorption can be salts within the water, in particular inorganic salts, graphite, or both. Such components can also provide IR-absorption. E.g. graphite particles can be comprised by the composition, which provide both, IR-absorption and microwave absorption. Graphite particles can be used as components of the composition which form an electrically conducting structure for absorbing microwave radiation, in addition to IR-absorption properties inherent to graphite particles (eg. due to their surface).

If microwave radiation is used with a frequency which is also employed in microwave ovens to prepare food (about 2.45 GHz), then the water or the silicates in the binder can be excited by the irradiation of the microwaves so that the composition is heated. Generally, frequencies within the ISM radio bands, e.g. 2.4 GHz-2.5 GHz, 902-928 MHz or other can be used (amongst others). Suitable frequencies are in particular 915 MHz. In particular, lower frequencies are preferred (here: 915 MHz in comparison to 2.45 MHz) due to the increased depths of penetration. Low frequencies, inherently linked with increased depths of penetration are particularly suited if the space to be heated has a depth of greater than 20 cm, 50 cm, 80 cm, 100 cm or 120 cm. In this context, the depths of penetration can be defined by a loss of microwave intensity of 3 dB, 6 dB or 10 dB along the mentioned distance propagated within the composition. In principle, all frequencies which lead to substantial absorption of radiation by materials containing water are suitable. In other words, the microwave radiation is resorbed in particular in the binder containing water.

The binder is preferably provided in such a way that, in the still fluid state, it contains microwave-resorbing materials or compounds which escape during solidification of the binder, so that the binder existing in the finished shaped foam body absorbs microwaves only to a small extent or essentially not at all, for example with microwave-transparent materials being used for the foam particles. This is the case in particular with binders containing water, the water evaporating during heating and escaping from the body being produced; the microwave radiation is scarcely resorbed in regions already free from water so as not to generate any unnecessary heating at these sites. The microwaves are therefore automatically resorbed only by the still moist regions, and the regions already heated sufficiently, which contain binder that is already dry, essentially let the microwave radiation passes through. Instead of water, it is also possible to use other solvents which as a binder solution can be excited by microwaves. When using microwave-absorbing materials as foam particles or (residual) binder, for example highly polar materials or material mixtures with conductive additives such as conductive solids (for example graphite particles) or when using (dissolved) salts, the composition will be heated further by the microwave irradiation even with a high degree of drying. The permeability for microwave radiation is furthermore dependent on the temperature of the composition.

The foam particles are preferably formed or already pre-foamed from fire-resistant materials, and are distributed homogeneously with the binder in the composition. In another preferred embodiment, the binder is formed as a coating on the foam particles, so that merely the coated foam particles form the composition. Waterglass, or other water-binding substances, e.g. silicates may in particular be used as binders. The binder may be mixed with further additives, e.g. film forming polymers, flameproofing agents or intumescent materials or combinations thereof. The binder may furthermore comprise hydraulic binders. In general, the binder is at least partially fluid, can be converted into a fluid state and solidified by heat.

The foam particles are in general (combinable) solids. The water content of the foam particles or the composition after drying preferably lies in the range of from 1 to 40 wt. %, particularly preferably in the range of from 2 to 30 wt. %, more particularly preferably in the range of from 5 to 15 wt. %. It may for example be determined by Karl-Fischer titration of the coated foam particles. The foam particle/coating mixture weight ratio after drying is preferably from 2:1 to 1:10, particularly preferably 1:1 to 1:5.

Expanded polyolefins such as expanded polyethylene (EPE) or expanded polypropylene (EPP) or pre-foamed particles of expandable styrene polymers, in particular expandable polystyrene (EPS) may be used as foam particles. In general, the foam particles have an average particle diameter in the range of from 2 to 10 mm. The bulk density of the foam particles is in general from 5 to 100 kg/m³, preferably from 5 to 40 kg/m³ and in particular from 8 to 16 kg/m³, determined according to DIN EN ISO 60.

Foam particles based on styrene polymers may be obtained by pre-foaming EPS with hot air or water vapor to the desired density in a pre-foamer. By pre-foaming one or more times in a pressure or continuous pre-foamer, final bulk densities of less than 10 g/l can then be obtained.

Owing to their high thermal insulation capacity, it is particularly preferable to use pre-foamed expandable styrene polymers which contain athermanous solids such as carbon black, aluminum or graphite, in particular graphite with an average particle size in the range of from 1 to 50 μm particle diameter in amounts of from 0.1 to 10 wt. %, in particular from 2 to 8 wt. %, expressed in terms of EPS, and are known for example from EP-B 981 574 and EP-B 981 575.

The foam particles according to the invention may furthermore contain from 3 to 60 wt. %, preferably from 5 to 20 wt. % of a filler, expressed in terms of the pre-foamed foam particles. Organic and inorganic powders or fiber substances may be envisaged as fillers, as well as mixtures thereof. For example wood flour, starch, flax fibers, hemp fibers, ramie fibers, jute fibers, sisal fibers, cotton fibers, cellulose fibers or aramid fibers, may be used as organic fillers. As inorganic fillers, for example carbonates, silicates, baryte, glass beads, zeolites or metal oxides may be used. Powdered inorganic substances are preferred, such as talc, chalk, kaolin (Al₂(Si₂O₅)(OH)₄), aluminum hydroxide, magnesium hydroxide, aluminum nitride, aluminum silicate, barium sulfate, calcium carbonate, calcium sulfate, silica, quartz powder, Aerosil, alumina or wollastonite, or inorganic substances in spherical or fiber form, such as glass beads, glass fibers or carbon fibers.

The average particle diameter, or for fibrous fillers the length, should lie in the range of the cell size or less. An average particle diameter in the range of from 1 to 100 μm is preferred, preferably in the range of from 2 to 50 μm.

Inorganic fillers with a density in the range of 1.0-4.0 g/cm³, particularly in the range of 1.5-3.5 g/cm³, are preferred in particular. The whiteness/brightness (DIN/ISO) is preferably 50-100%, in particular 60-98%.

The type and amount of the fillers can influence the properties of the expandable thermoplastic polymers and the shaped particle foam parts obtainable therefrom. By using adhesion promoters such as styrene copolymers modified with maleic anhydride, polymers containing epoxide groups, organosilanes or styrene copolymers with isocyanate or acid groups, it is possible to improve significantly the binding of the filler to the polymer matrix and therefore the mechanical properties of the shaped particle foam parts.

In general, inorganic fillers reduce the combustibility. The burning behavior can be further improved in particular by adding inorganic powders such as aluminum hydroxide, magnesium hydroxide or borax.

Such foam particles containing fillers may, for example, be obtained by foaming expandable thermoplastic granules containing fillers. In the case of high filler contents, the expandable granules required for this may be obtained by extrusion of thermoplastic melts containing a blowing agent and subsequent underwater pressure granulation, as described for example in WO 2005/056653.

The polymer foam particles may additionally be provided with other flameproofing agents. To this end, for example, they may contain from 1 to 6 wt. % of an organic bromine compound such as hexabromocyclododecane (HBCD), and optionally also from 0.1 to 0.5 wt. % of dicumyl or a peroxide inside the foam particles or the coating. It is, however, preferable not to use flameproofing agents which contain halogens.

According to the invention, a composition having such foam particles and binder is put into a space which is bounded by a pressing surface on at least one side. This pressing surface is used to exert pressure onto the composition, by exposing the pressing surface and/or a counterbearing surface to a force with which it acts on the composition. Microwaves are furthermore irradiated through the pressing surface (and/or the counterbearing surface) into the composition, while pressure is exerted onto the composition. During the irradiation of microwaves, pressure can be exerted onto the composition so that the space which contains the composition is reduced. This corresponds to compression of the composition.

The pressing surface may be continuous or may be provided with recesses, for example as bars, the average surface coverage of the pressing surface preferably being more than 50%, more than 75% or more than 90%, and the free surfaces existing between the pressure-exerting sections of the pressing surface being smaller than the foam particles. The pressing surface preferably comprises material which is transparent for microwaves, or has a structure which is transparent for microwaves, or both.

The exertion of pressure preferably comprises pressing a stiff layer, which locally or entirely is essentially transparent for microwaves, this being provided by the structural properties, the material properties or both these properties. The stiff layer is used to exert the pressure onto the composition inside the space, one option being for the stiff layer itself to have a surface which faces toward the space and corresponds at least partially to the pressing surface. As an alternative, the stiff layer or its surface may exert the pressure onto the composition via a microwave-transparent interlayer, the interlayer providing the pressing surface. In another embodiment, the pressing surface is provided by an additional layer, which is arranged between the interlayer and the space that contains the composition. The microwave-transparent interlayer is not necessarily stiff and may also be provided as a flexible layer, for example in the form of a pliable sheet or a textile made of plastic, which is preferably transparent for microwaves. Preferably, all the layers between the microwave source and the space which contains the composition are made of microwave-transparent material or at least have a structure through which microwaves can pass. The stiff layer may be provided as an inelastic layer (owing to material properties and thickness) or it may be provided as a flexible layer, which is tautened and therefore has stiff properties relative to the composition to be pressed.

The interlayer is preferably displaceable relative to the stiff layer, or removable from it.

The pressing surface is preferably connected to external elements so as to transmit force, whether through further layers such as the interlayer or the stiff layer or directly. The microwaves are preferably irradiated from a microwave radiator unit, the microwave radiator unit being located outside the pressing surface and outside the space. In particular, the stiff layer is connected to the interlayer so as to transmit force, in order to deliver a force acting on the stiff layer through the interlayer and the pressing surface into the space, i.e. onto the composition contained in the space.

All the components lying between the microwave radiator unit and the space, in particular the pressing surface, are preferably transparent for microwaves owing to material constitution or structure. All the layers between the microwave radiator unit and the foam body being produced, in particular the component or layer which constitutes the pressing surface, are therefore transparent for microwaves so that much less than 50% of the power is absorbed there, preferably less than 10%, less than 5%, less than 1% or less than 1%. In particular, the stiff layer is preferably made of a material which absorbs essentially no power for microwaves that are suitable for the excitation of water, and for this frequency has a complex relative dielectric constant whose phase is less than 5%. One or more polypropylene plates (eg. stacked plates) are preferably used as the transparent interlayer. Risopal plates, i.e. coated wood, are furthermore suitable. Preferably, however, polypropylene, polyethylene or Teflon is used as the material. These materials may also be combined, by using one of these materials as a coating of another of said materials. Nonstick materials are preferably used as the coating, for example dry lubricant coatings or perfluorethylenepropylene, PTFE or perfluormethyl vinyl ether coatings. The coatings bound the space which contains the composition.

The microwaves are generated by a microwave radiator unit and radiated into the space. The microwave radiator unit preferably comprises a plurality of antennas, which are arranged flat and parallel to the pressing surface in order to emit microwave radiation directed toward the pressing surface. The microwave antennas are preferably in not excited via single radiofrequency sources which are respectively allocated to exactly one microwave antenna, but instead via a distributor instrument, at least two of the microwave antennas being combined via the distributor instrument and supplied from a common microwave signal source, preferably via a passive distributor circuit. Preferably, all the microwave antennas of the microwave radiator unit are coupled together via the distributor instrument, in order to be supplied with microwave power from a single common microwave signal source which is likewise connected to the distributor instrument. The distributor instrument ensures distribution of the microwave power in equal parts to the microwave antennas, and furthermore ensures matching of the antennas to the microwave signal source.

As the microwave antennas, it is preferable to use rod antennas which are designed as λ/2 or λ/4 antennas. These are preferably aligned mutually parallel. The distance between the microwave antennas is preferably such that, taking into account the frequency of the microwave signal, only minor spatial variations of the field strength occur, with variations in the form of relative minima preferably occurring in narrowly delimited sections of the space. The arrangement of the microwave antennas, in combination with the choice of frequency of the microwave signal, preferably provides an interference pattern inside the space which allows homogeneous temperature distribution, with thermal transfer processes inside the foam body being produced also contributing to temperature equilibration besides the homogeneity of the field strength. According to another embodiment of the invention, the microwave radiator unit is equipped with a distributor device which generates repeating phase shifts between the microwave antennas connected to it, so that the interference pattern inside the space changes constantly. Time averaging and integration of the instantaneous irradiated power (including by thermal diffusion) therefore gives a homogeneous temperature distribution, despite the use of interference patterns with essential inhomogeneities relating to a fixed time. The desired homogenizing effect in respect of the temperature distribution inside the space is obtained because the interference pattern changes with time, constantly or recurrently owing to the phase shift which is provided by the distributor device.

The method according to the invention provides for the irradiation of microwaves by exciting a plurality of microwave antennas, arranged flat and parallel to the pressing surface, with a common radiofrequency microwave signal which is fed via a distributor instrument from a radiofrequency source to at least two or all of the microwave antennas. The microwave energy radiated by the microwave antennas is directed into the space. The antennas radiate through the pressing surface, through the counterbearing surface which may substitute for the pressing surface, or through both.

As an alternative to rod antennas, horn radiators which are aligned at the space may also be used as microwave antennas. The alignment of all the horn radiators is preferably the same. The horn radiators do not adjoin one another directly, but have a spacing that makes it possible to provide a holding device between the respective antennas, which can be loaded sufficiently with pressure in order to transmit the pressure which is exerted onto the pressing surface. This holding device preferably extends along the plane of the emission ends of the horn radiators and may be made of metal, plastic, in particular microwave-transparent material. When employing rod antennas, it is also possible to use a holding device which has recesses for the rod antennas (for example in the form of a multiple frame) with further components that transmit the pressure onto the pressing surface resting on the holding device. When using rod antennas, they will be fitted inside the recesses of the holding device and therefore not touch the holding device, in contrast to horn antennas. The multiple frame produces a grid of bars on which further components, for example the rigid layer, may rest in order to be able to transmit pressure to the pressing surface. In the case of rod antennas, the holding device is preferably made of a microwave-transparent material with sufficient wall thickness, so that the radiation pattern of the rod antennas is not affected to a particularly great extent.

The microwave antennas, which form the microwave radiator unit, may be designed as rod antennas or horn antennas, and are preferably formed periodically as a single-line array. As an alternative, the microwave antennas may also be formed as a multi-line array i.e. as a matrix, all the antennas of the array having the same number of microwave antennas which are arranged with the same mutual spacing in each array. A reflector surface may respectively be arranged next to the individual antennas, preferably when using rod antennas. In the case of a multi-line array, each array may be supplied from a microwave signal source via a distributor device, or all the microwave antennas of all the arrays may be fed via a common distributor device from a common microwave signal source. Since only a fraction of the microwave signal sources are required with the distributor device, in the extreme case only one microwave signal source, the costs for the device according to the invention are reduced. Particularly when using waterglass or other water-containing silicates as binders, which are exposed to temperatures lower than 80° C., with a high or medium power microwave signal source it is possible to cover a large area since the temperature to be reached, which leads to solidification of the binder, does not require particularly high powers.

In principle, the shaped foam body method according to the invention may be continuous (endless band) or provide individual manufacture. In order to produce endless shaped foam bodies, for example in the form of an insulation layer with a uniform cross section, a conveyor belt will be used which feeds the composition through the space continuously or at least periodically. During residence in the space, the composition contained in the space will simultaneously be exposed to a pressure and heating which is caused by the microwave irradiation.

The pressure may be exerted by a roller and a counterbearing surface, or a roller pair, which is connected indirectly or directly to the pressing surface. Advantageously, rollers made of a microwave-transparent material will be used for this. When using rollers, the pressure exerted by the pressing surface is not constant over the entire surface but essentially restricted to the contact surface of the rollers. The rollers may exert a pressure directly onto the composition, or they may exert pressure onto the composition contained in the space via a separating surface or an interlayer. The interlayer may be used to distribute the pressure generated by the rollers, microwaves being irradiated into the space through the interlayer. Pressure may furthermore be exerted onto the composition inside the space by the conveyor belt, in particular through the rollers of the conveyor belt and through a tautened belt which forms the conveyor belt. Owing to the tension inside the tautened belt, it fulfils the function of the second layer since it experiences just as little essential deformation as the stiff layer when exerting pressure.

The conveyor belt is continuous and closed on itself, the belt being reversed at two mutually opposite positions by two rollers arranged mutually opposite. The conveyor belt may be designed as a flexible belt, for example as a textile belt, a plastic belt, or rubber belt. As an alternative, the conveyor belt may be designed as a chain-link belt that comprises a multiplicity of rigid chain links arranged sequentially, which can tilt relative to one another. The chain links preferably form a virtually closed plane surface between the turnaround points, in which case the rollers may comprise toothed wheels which engage into the chain links in order to drive the conveyor belt. Both variants may furthermore comprise supporting rollers, which are arranged at positions between the turnaround points in order to support the surface formed by the conveyor belt, which faces toward the space, from the corresponding lower side of the conveyor belt.

In particular when the conveyor belt is designed as a chain-link belt, also known as a flat link chain or caterpillar chain, it is possible to provide high homogeneously distributed forces which are exerted by the individual rigid chain links and therefore by the pressing surface. A flexible belt, which forms the conveyor belt, may also be tautened with high mechanical tension in order to exert pressure. According to one embodiment not just (at least) one surface is formed by (at least) one conveyor belt, but also (at least) one further side conveyor belt forms (at least) one side surface which is perpendicular to the surface(s) of the conveyor belt described above and adjoins it directly along one edge. The space can thus be enclosed by conveyor belts that extend along mutually perpendicular planes, which are in turn aligned along the conveying direction. The space may for example be enclosed by four surfaces, which are arranged mutually parallel in pairs and meet one another at an angle of 90°. The surfaces then form a tunnel-shaped space with a closed rectangular cross section. The rates of advance of all the surfaces, which are provided by conveyor belts, are preferably equal.

According to another embodiment, the composition is delivered by (at least) one conveyor belt into a section with a stationary pressing surface and a stationary counterbearing surface. To this end, the composition is (slightly) pre-compressed in order to touch both surfaces inside the section and exert a (slight) pressure, which is caused by the restoring forces of the composition, onto the surfaces due to the elastic properties of the composition. The pressing surface and counterbearing surface then work as passive compression surfaces. In this section the pressing surface, counterbearing surface or both are formed by microwave-transparent flexible or rigid layers. In the case of flexible layers, they will be supported by a rigid layer. Microwaves are irradiated into the space next to the surfaces through this layer or these layers transparent for microwaves.

The conveyor belt may however also be used merely to deliver the composition inside the space (as well as outside), the pressing surface exerting pressure onto the composition by means of a periodically rising and falling plunger. The repetition rate of the plunger is preferably greater than the rate of advance so that each surface point of the composition comes into contact with the pressing surface at least once. The pressing surface may be lowered directly onto the composition, or it may be lowered onto the composition via an interlayer. The plunger provides a plunger surface which is connected to the pressing surface so as to transmit force (at least when the plunger has been lowered onto the composition), microwave radiation being irradiated into the space through the plunger surface. The stroke of the plunger is preferably small so as to permit a short distance between the microwave antennas and the pressing surface, for example less than 30 cm, less than 20 cm or less than 10 cm, in order to allow directed irradiation of microwaves into the space despite the separation.

As a counterbearing for the pressure exerted by the roller, the conveyor belt or the plunger, a stationary counterbearing surface may be used or opposing components of the same type may be used so as to form a roller pair, conveyor belt pair or plunger pair. The components may also be combined together, in which case for example a plunger may oppose a conveyor belt and both exert pressure onto the composition between them. A stationary counterbearing surfaces also exerts pressure onto the composition, since the sum of all the forces of the system is zero and the (pressurized) pressing surface exerts pressure the composition that in turn presses against the counterbearing surface, which in response exerts pressure onto the composition in the opposite direction. Microwave radiation is irradiated from the outside into the space through at least one of these surfaces exerting pressure passively or actively.

In principle, a pressing surface and opposing counterbearing surface may be movable relative to one another. As an alternative to this, however, a pressing surface and opposing counterbearing surface may be exposed to a pressure which results from compression of the composition between them. In this case neither the pressing surface nor the counterbearing surface will be moved actively, but instead will be pressed by a spring force (for example generated by spring elements) against the composition in order to exert pressure onto it. This also applies for example in the case of a stationary roller pair or in the case of a conveyor belt pair. If actively moved components are used in order to move the pressing surface or alternatively the counterbearing surface, then this movement will comprise an essential longitudinal movement component which is directed perpendicularly to the extent of the counterbearing surface, or the pressing surface.

In principle, the microwave radiation may be introduced into the space both through the pressing surface and through the counterbearing surface. If the microwave radiation enters the space only through the pressing surface and not through the counterbearing surface, however, then the latter may also be made of metallic material or other materials which reflect microwaves. Further, the microwave radiation may be introduced into the space from a surface distinct to the pressing surface and the counterbearing surface, e.g. from a lateral surface of the space. This lateral surface does not exert pressure.

For alignment or collimation of the energy emitted by the microwave antennas, it is possible to use reflecting surfaces which, in the case of rod antennas, will be formed around them and separated from them, and by the aperture surfaces of the horn in the case of horn radiators. Both cases give the desired directional effect for irradiating the microwave power into the space.

If it is transparent for microwaves, microwave radiation may be irradiated in through the plunger surface. Microwave radiation may furthermore be irradiated into the composition through the counterbearing surface, which lies opposite the plunger surface, if it is transparent for microwaves according to a particular embodiment. In principle microwave radiation can be irradiated from both opposite sides (pressing surface/counterbearing surface) through the respective side into the space which contains the composition, or from only one side (i.e. through the pressing surface or counterbearing surface). If irradiation takes place only from one side, then the layer or component which provides the corresponding surface will be made of a material which is transparent for microwaves, at least between the microwave radiator unit, or it will have a structure which lets microwaves pass through and permits microwave irradiation. In principle both opposite surfaces (pressing surface and counterbearing surface) may be mobile in order to exert pressure (example: two opposing plungers), only one of these surfaces may be mobile (example: one plunger with an opposite counterbearing surface which a stationary, or supported by a conveyor belt), or both surfaces may be stationary, for example two opposing conveyor belts; in the latter case, the pressure comes from the composition which has been compressed in a preceding step or device section and the restoring force of the composition therefore exerts the pressure required for compression. In this context, stationary means that the corresponding surface can move only in the direction of the space. In the case of two passive surfaces i.e. two stationary surfaces, the composition inside the space will be compressed to a shape/thickness which essentially corresponds to the desired final shape. Stationary surfaces may also be regarded as passive surfaces for passive pressure generation, and mobile surfaces which are used for volume reduction may also be referred to as active surfaces for active pressure generation. The exertion of pressure may therefore be provided passively (for example by the restoring force of the composition or by a stationary surface) or actively (for example through volume reduction by a plunger or by at least one conveyor belt which extends at an angle to the opposite surface and therefore narrows the space in the direction of advance).

Specific examples will be given below, each of which is designed according to a specific set of composition and process parameters. The examples are used to present some embodiments exemplifying the invention.

### Examples 1-5c

### Setting a Coating Containing Silicates by Means of Microwave Horn Radiators

### Substance Mixture Used (A):

A mixture of solid waterglass (100 parts, 80% solid), kaolin (100 parts) and titanium dioxide (20 parts) is provided as the composition, which is homogenized. To this end water (100 parts) and Acronal S790 (22 parts) are stirred until a homogeneous viscous composition is obtained. The mixture is added in the ratio 4:1 to pre-foamed Neopor N2300 (raw density 10 g/L) and distributed uniformly. Acronal S790 is an acrylate/styrene dispersion; Neopor N2300 is an expandable polystyrene (EPS) with a flameproofing agent in uniform distribution (blowing agent: pentane) in pearl form with a size range of 0.8 mm-1.4 mm and a moisture content of max. 3%.

This mixture (substance mixture A) is used as the starting basis for all the tests described below (cf. Table 1).

### Conduct of the Microwave Tests

The tests are carried out according to an embodiment of the invention with the batch method in a rectangular aluminum container lined with plastic plates made of polypropylene, whose interior forms a microwave cavity with a length of 580 mm and a width of 280 mm and which is closed by a mobile plunger (made of aluminum and polypropylene). Starting with substance mixture A, in each case the microwave cavity is filled (filling level 170 mm) and the plunger is fitted. The plunger is subsequently moved to a previously defined compression factor. To this end, a pressure of from 2.5 to 3 bar gauge is exerted onto the plunger; the pressure is maintained throughout the entire test in order to overcome the restoring forces of the compressed substance mixture. The compression is expressed in [%] of the initial volume. The separation describes the distance between the substance mixture and the apertures of the microwave horn radiators; this separation can be varied using a stack of plastic plates made of polypropylene which are placed onto the bottom of the cavity. The three temperatures indicated (T1-T3) describe three measurement points in the compressed foam body (left, middle, right) where the temperature was measured after the time described in Table 1. The temperatures for the respective test reflect the homogeneity of the temperature distribution.

TABLE 1

| | Power | T | Compression | Separation | T1 | T2 | T3 |
|---|---|---|---|---|---|---|---|
| Test | [kW] | [min.] | [%] | [cm] | [° C.] | [° C.] | [° C.] |
| 1 | 2 × 1.2 | 2 | −25 | 15 | 67 | 85 | 82 |
| 2 | 2 × 1.2 | 2 | −40 | 15 | 63 | 53 | 53 |
| 3 | 2 × 1.2 | 3 | −40 | 15 | 89 | 76 | 82 |
| 4 | 2 × 1.2 | 3 | −40 | 15 | 87 | 67 | 89 |
| 4b | 2 × 1.2 | (+) 1 | −40 | 15 | 88 | 74 | 88 |
| 4c | 2 × 1.2 | (+) 1 | −40 | 15 | 92 | 80 | 90 |
| 4d | 2 × 1.2 | (+) 1 | −40 | 15 | 95 | 93 | 90 |
| 5 | 2 × 0.6 | 2 | −40 | 15 | 69 | 55 | 82 |
| 5b | 2 × 0.6 | (+) 1 | −40 | 15 | 76 | 62 | 88 |
| 5c | 2 × 0.6 | (+) 1 | −40 | 15 | 79 | 67 | 89 |

Owing to the design configuration of this apparatus, the examples only describe compression factors of from 25 to 40%; however, compressions of −50% are preferably used in the scope of the invention. In Tests 3-5, the cavity is under vacuum (about 0.5 bar) during the tests.

### Results of the Horn Radiator Tests

The following list describes the observations made during the test.

Although the foam body can be released from the mould according to Test 1, it does however exhibit rather weak welding of the coated granule particles.

Test 2: similar to the observations in Test 1, but the foam body according to Test 2 still has a detectable restoring force so that the plunger was pressed up again after the application pressure was turned off (reason: deformation of the foam body, restoring force).

In the tests above, it was found that the released water hindered setting of the foam body, for which reason the apparatus was connected to a vacuum system for Tests 3 to 5. It was found that a vacuum should no longer be connected during the temperature measurement or else the temperature measurement is vitiated.

Tests 4-4d represent stepwise heating. While Test 4 is a replica of Test 3, in the subsequent Tests 4b-4d the foam body was heated further for 1 minute in each case. Subsequently (after the end of 4d), the foam body was released from the mould and exhibited significant sinter traces in the exit region of the horn radiators. On the other hand, the regions which were not reached directly by the microwave radiation (“shadow zones”) showed virtually no welding.

Tests 5-5c were intended to check whether it is possible to achieve more homogeneous heating by reduction of the energy input together with longer exposure of the material. Although the specimen was heated more slowly in this case, undesired “shadow zones” were however found similarly as in 4.

The tests presented were also carried out inter alia in order to determine minimum time requirements.

### Examples 6-9

### Setting a Coating Containing Silicates by Means of Microwave Antenna Radiators

### Conduct of the Tests:

Starting with substance mixture A (see above), the microwave cavity is in each case filled and closed with the mobile plunger. It is subsequently compressed to a predefined compression factor. To this end, a pressure of from 2.5 to 3 bar gauge is exerted onto the plunger. The compression is expressed in [%] of the initial volume. The separation describes the distance between the substance mixture and the plane on which the microwave antennas are arranged. This separation can be varied using a stack of plastic plates made of polypropylene which are placed onto the bottom of the cavity. The “final block height” indicates the height of the microwave cavity, which corresponds to the height of the compressed foam body. The three temperatures indicated (T1-T3) describe three measurement points in the compressed foam body (left, middle, right) where the temperature was measured after the time described in Table 2. In contrast to Examples 1-5, this time the walls of the cavity are provided with regularly arranged grooves. The grooves are arranged so that they form a corresponding system which is evacuable. Water being formed can therefore be discharged out from the microwave cavity through the channels which are formed by the grooves.

TABLE 2

| | | | | Final | | | | |
|---|---|---|---|---|---|---|---|---|
| | | | Com- | block | Sepa- | | | |
| | Power | t | pression | height | ration | T1 | T2 | T3 |
| Test | [kW] | [min.] | [%] | [cm] | [cm] | [° C.] | [° C.] | [° C.] |
| 6 | 2 | 1 | −40 | 10 | 3 | 55 | 58 | 56 |
| 6b | 2 | (+) 1 | −40 | 10 | 3 | 72 | 75 | 61 |
| 7 | 2 | 2 | −40 | 10 | 3 | 66 | 73 | 70 |
| 8 | 2 | 2 | −40 | 10 | 12 | 65 | 67 | 75 |
| 9 | 2 | 3 | −40 | 13 | 6 | 63 | 59 | 55 |

### Results of the Antenna Radiator Tests

The following list describes the observations made during the test.

The finished foam body is immediately shape-stable and can readily be released from the mould and transported. The walls of the cavity, however, are still moist. To this end Example Test 6b was reproduced but with longer microwave exposure. It was found that the applied vacuum contributes significantly to the material drying. The separation between the radiators and the material was increased in Example Test 8, but this made no difference to the quality of the foam body in respect of its mechanical properties. In Example Test 9, a foam body with a larger thickness was produced. It was found that larger material thicknesses need to be exposed for a correspondingly longer time in order to achieve the same final temperatures.

The tests lead to the following conclusions, which apply to all the embodiments:

The quantities of water or water vapor formed are preferably removed, in particular from the vicinity of the antennas. The surface, through which the microwave radiation enters the cavity, is therefore preferably equipped with a channel or groove system or with bores which are used to remove the emerging water outward. Otherwise, these quantities of water reduce the efficiency of the microwave radiation. The groove system can be provided as checkerboard like system comprising first equidistant, parallel groves and second equidistant, parallel groves perpendicular thereto, wherein the grooves extend within a plane and are extended over a complete inner side of the room.

Besides correspondingly modified side walls, bottom or top surfaces through which the water or water vapor can emerge when carrying out the tests, the water extraction may also be assisted by a vacuum.

### Additional Experimental Data

Table 3 shows experimental data concerning the process according to invention for manufacturing of shaped foam bodies and shaped foam plates as well as the results achieved with the inventive process. The foam bodies could be provided as dry and well demolded shaped foam bodies.

### Set-Up

The process has been carried out in batch mode in an apparatus providing an inner space of 1250×1100×350 mm (shape of resulting pressed blocks). Thus, the used apparatus is substantially larger than the apparatus used within the experiments described above. The following relates to a set-up in which the larger apparatus has been used (inner size 1250×1100×350 mm).

The apparatus used for the experiments comprises a container of Al and steel, in which plastic plates are located. The plastic plates were made from polytetrafluoroethylene or polypropylene, wherein the plastic plate abutting to the space (and to the introduced composition) are made of polytetrafluoroethylene (at least at the surface abutting to the space). In the plates, a micro wave antenna opening is located for accomodating an micro wave antenna array with the size of 1250 mm×1100 mm. Thus, the array extend over the complete surface of one side (the bottom side) of the container. The container has a rectangular shape. The space within the container is closed by a plunger one side of the space (i.e. the upper side). The plunger is movable and is made of steel, Al and polytetrafluoroethylene, wherein the surface abutting to the space is of polytetrafluoroethylene.

The container is designed to be operated under vacuum in the range of ca. 0 bar-1 bar within the inner space. The plastic plates forming the lining of the micro wave antenna opening, which are in direct contact to the space (i.e. to the composition) have a surface comprising cross-wise extending grooves (1 mm to 5 mm width and 4 mm to 6 mm depth) for allowing an efficient ventilation during pressing and heating the composition.

The container comprises a metal door at a front side (or at a lateral side of the container), which is closed during filling and pressing/heating. At the beginning, the door is closed and the plunger of a press (both being part of the apparatus), including a hood of the plunger, are supported by rails extending parallel to the upper side of the container. The plunger and the press are completely retracted from the upper opening of the container in order to open the container completely. Then, the composition is filled into the inner space of the container. The composition is filled into the space with a height in the range of 100 mm-600 mm. The upper surface of the introduced composition is smoothed and the plunger is positioned over the composition by moving the press, the hood and the plunger using the rails. In the following, the plunger of the press is pressed onto the composition for providing a predefined degree of compression. An hydraulic unit of the apparatus connected to the press exerts a pressure of about 1 to 2 bar, or 4 bar at maximum on the plunger. This pressure is maintained during the complete experiment in order to overcome the restoring force of the compressed composition. The compression is given on [%] of the starting volume.

A distance is given between the deepest point of the composition (the bottom surface of the space) and the micro wave antennas. This distance can be varied by the number and thickness of plastic plates between micro wave cavity and space. After the plunger has reached the predefined end position, vacuum is applied to the space, which can be regarded as microwave cavity.

The applied vacuum is given in [bar absolut]. After being evacuated, the micro wave cavity is irradiated by an array of 24 parallel microwave rod antennas from the bottom of the container and through the plastic plates between antenna array and space (=microwave cavity). The antennas are connected to three power splitters each on two opposing sides of the container. Each of the 2×3 power splitters is connected to a microwave generator, wherein each of the 6 microwave generators can be (individually) adjusted to an output power of 0-2000 W. Thus, the micro wave power emitted into the micro wave cavity can be distributed with a high spatial homogeneity as far as the cavity itself does not provide a high homogeneity. In particular, the cuboid shape of the space itself allows a homogeneous distribution of macro wave power, which, however, could be enhanced or suitably adapted by individually adjusting the power of the micro wave generators.

The emission of microwaves is continued until the shaped foam bodies are substantially hardened or provide a stable mechanical form. Thereupon the plunger is lifted and is, together with the hood, retracted by moving the hood and the plunger over the rails to open the upper opening of the container. The front door (located at a lateral position of the container) is opened and the hardened shaped form body is moved by a laterally moving ejection plunger, together with the lining plates (ie. at least one bottom plate and two or four lateral plates) onto a movable carriage in front of the container. The lining plates are formed of PTFE or have a surface abutting to the space made thereof. Outside the cavity (ie. outside the apparatus), the lining plates made of plastic material are removed and are cleaned (if necessary) and are reintroduced into the container.

The following shows the experimental results

TABLE 3

| | | | | | | vacuum | |
|---|---|---|---|---|---|---|---|
| | | thick- | vol- | dura- | μW- | pressure | |
| experi- | com- | ness | ume | tion | power | (mbar | ventilation |
| ment | position | (cm) | (m³) | (h) | (kW) | abs.) | medium |
| a | 2 | 22 | 0.3 | 65 | — | 850 | (e) |
| b | 1, 2, 3, 4 | 22 | 0.3 | 18 | — | 500 | (e) |
| c | 2 | 22 | 0.3 | 12 | — | 500 | (d) |
| d | 5 | 22 | 0.3 | 11 | — | 500 | (d) |
| e | 1, 1A | 11 | 0.15 | 3 | 1.5-0.5 | 850 | (e) |
| f | 2 | 22 | 0.3 | 2.5 | 0.8 | 800 | (e) |
| g | 2 | 22 | 0.3 | 1.75 | 0.8 | 800 | (d) |
| h | 2 | 22 | 0.3 | 1.5 | 0.8 | 500 | (d) |
| i | 2 | 22 | 0.3 | 2.0 | 0.8 | 300 | (d) |
| k | 2 | 22 | 0.3 | 1 | 0.85 | 500 | (d) |
| l | 2 | 13 | 0.18 | 0.5 | 1.1-0.5 | 500 | (d) |
| m | 2 | 30 | 0.41 | 1.75 | 1.1-0.5 | 500 | (d) |

with: ventilation medium:
(e): environmental air;
(d): dried air.

The resulting shaped foam bodies have a stable form right after ejection from the microwave cavity and can be demoulded and transported without any loss of quality.

Example b shows that a higher vacuum leads to dryer material. Surprisingly, a further decreased pressure does not result in decreased duration of the drying/hardening process, cf. example i. The reason therefore seems to be the decreased ventilation of the shaped foam body during the compressing operation since the higher vacuum (=decreased pressure) has been realized by decreasing the input air stream at a maintained vacuum pump rate.

In example I a shaped foam body of reduces thickness has been produced. It was concluded that thinner foam bodies have to be irradiated for a shorter duration as compared to thicker foam bodies.

Examples f and g show that the duration of the manufacturing process can be significantly reduced by using dry air for ventilation as compared to environmental air. The environmental air and dry air, respectively, has been directed through the space of the container by the application of vacuum, wherein the main part of the amount of air is directed along the groove system at the surface of the shaped foam body, wherein only a small part of the amount of air is directed through the shaped foam body.

In view of examples k and I it is clearly shown that the combination of the micro wave radiation, dry air and an optimum vacuum leads to a reduced duration of 30 minutes, in comparison to 65 hours without micro wave radiation, dry air and vacuum. For the given device and the composition and thickness stated in table 3 and in the following, an amount of air (air supply rate) of more than 100 m³/h at 500 mbar/abs and an initial microwave power of 6×1.1 bis 1.5 kWh (depending on the thickness), which has been reduced successively to 0 kWh, is considered as a preferred embodiment of the invention. The air supply rate has to be set into relationship to the volume or cross sectional area (perpendicular to the air stream direction) within the container if other container sizes are applied.

In Example m, a shaped foam body with an increased thickness has been produced. According to this example, an increased requires a longer duration of irradiation.

In a general aspect of the invention, compositions 1-5 as used in the experiments comprise components as follows:
a. 20-70 wt. % of ceramic material
b. 0-70 wt. % of an alcaline silicate
c. 1-60, in particular 20-40 wt. % nanoscale SiO₂ particles
d. 1-30 wt. % of a film forming polymere
e. 0-40 wt. % of infrared-absorbing pigments

In particular, the compositions of table 3 are as follows:

| | | | amount | | |
|---|---|---|---|---|---|
| slurry | | solids | expanded | | |
| (composition | mass | content | polystyrene | O-salt = | O:slurry = |
| before drying) | [g] | [g] | (EPS) [g] | 1:x | 1:x |
| Composition 1 | | | | | |
| wollastonite | 6952 | 6952 | 3797 | 3.9 | 5.8 |
| Betolin K42 | 3476 | 1460 | | | |
| titan dioxide | 1166 | 1166 | | | |
| Acronal | 1166 | 583 | | | |
| Levasil 50/50% | 9262 | 4631 | | | |
| Composition 1 A | | | | | |
| Portil N | 4861 | | 3795 | 2.7 | 4.3 |
| Kaolin | 4861 | | | | |
| titan dioxide | 972 | | | | |
| Acronal S 790 | 1066 | | | | |
| Water | 4800 | | | | |
| Composition 2 | | | | | |
| Levasil 50/50 | 5789 | 2894.5 | | | |
| Woellner K42 | 2173 | 912.66 | 3797 | 2.4 | 3.6 |
| Wollastonit | 4345 | 4345 | | | |
| titan dioxide | 729 | 729 | | | |
| Acronal S 790 | 729 | 364.5 | | | |
| Composition 3 | | | | | |
| Levasil 50/50 | 7084 | 3542 | | 2.0 | 3.0 |
| Woellner K42 | 2661 | 1118 | 5699 | | |
| Wollastonit | 5316 | 5316 | | | |
| titan dioxide | 885 | 885 | | | |
| Acronal S 790 | 885 | 442 | | | |
| calcium hydroxid | 110 | 110 | | | |
| Composition 4 | | | | | |
| Levasil 50/50 | 5972 | 2986 | | 1.7 | 2.6 |
| Woellner K42 | 2559 | 1074.78 | 5699 | | |
| Wollastonit HW-7 | 5119 | 5119 | | | |
| Titandioxid | 0 | 0 | | | |
| Acronal S 790 | 853 | 426.5 | | | |
| calcium hydroxide | 107 | 107 | | | |
| Composition 5 | | | | | |
| Levasil 50/50 | 4572 | 2286 | | 1.3 | 2.0 |
| Woellner K42 | 1959 | 822.78 | 5706 | | |
| Wollastonit HW-7 | 3919 | 3919 | | | |
| titan dioxide | 0 | 0 | | | |
| Acronal S 790 | 653 | 326.5 | | | |
| calcium hydroxide | 82 | 82 | | | |

Levasil® is an aqueous dispersion of available from H.C. Starck, Germany; Betolin K42 is a sodium silicate solution product available from Woellner GmbH & Co. KG, Germany; Acronal is an aqueous dispersion of styrenacrylate available from BASF SE, Germany; and Portil N is a sodium silicate solution available from Henkel KGaA/Germany. As expanded polystyrene (EPS), Neopor by BASF SE, Germany has been used. Where stated in Table 3, Acronal is identical to Acronal S 790 and Wollastonit is identical to Wollastonit HW-7.

The term O: salt is the mass ratio of organic foam particles in relation to the dry content of the binder. The term O: slurry is the mass ratio of organic foam particles in relation to water containing binder as used for the coating of the foam particles.

In the examples of table 3, the following drying results have been obtained.

TABLE 4

| | before | after | 24 hrs | After reaching |
|---|---|---|---|---|
| | drying/ | drying/ | after drying/ | constant |
| experiment | pressing | pressing | pressing (*) | weight (**) |
| a | 26.6% | 1.40% | 0.34% | 0.13% |
| b | 26.6% | 12.91% | 10.20% | 0.13% |
| c | 26.6% | 11.10% | 10.20% | 0.14% |
| e | 26.6% | 0.46% | 0.11% | 0.10% |
| g | 26.6% | 4.82% | 4.78% | 0.15% |
| i | 26.6% | 7.63% | 5.26% | 0.25% |
| k | 26.6% | 0.85% | 0.62% | 0.31% |

The percentage relates to the weight of the shaped foam body. The entries to (*) relate to the weight after 24 h of storing. The entries to (**) relate to the weight after 5 h at ambient temperature or after 1-2 days at 70-75° C.

According to table 4, drying without the use of microwaves (a-c) requires a long time and leads to a high amount of water in the foam body. In comparison thereto, the results to e-k using micro waves for drying show low percentages of water eventhough the drying time was comparably short. In particular from examples (e) an (k) it can be seen that drying/pressing according to the invention removes all removable water (compare 3^{rd} column to last column). Also g-k show that the inventive method removes water from the composition in an efficient way, the remaining water is neglectable. Thus, the foam bodies manufactured according to the invention do not undergo a reshaping process due the removal of water after the manufacturing process, which might lead to bending of the foam body. Further, it can be seen that also the center region of the foam body is effectively dried since only a neglectable amount of water can be removed in an enhanced drying step (1-2 days at 70-75° C.). Any wet regions, eg. in the center of the foam body, however, would inherently result in an additional amount of removed water due to the enhanced drying process the results of which are shown in the last column.

In a preferred embodiment of the invention, the space has a depth which is more or less a multitude of the thickness of yielded shaped foam plates. The method is carried out in batch mode and a block with a high thickness and a desired width and length is produced. The thickness can be more than 20, 30, 40, 50, 60, 80 or even 120 cm. After the block has been dried, the block is cut into plates of equal thickness. In this way, a multitude of plates can be produced within one drying process, which significantly increases the productivity. For drying a block (i.e. a shaped foam body) with such a high thickness, micro waves with a long wave length are preferred, e.g. with a frequency of below 1 GHz, in particular ca. 915 MHz (ISM band). In this way, the depths of penetration allows to dry the inner region of the block with a intensity comparable to the intensity at an outer region of the block. Further, compositions with a low percentage of water are preferred, which additionally increases the depth of penetration of the microwaves. Preferred percentages of water are not more than 35 wt. %, 30 wt. %, 27 wt. %, 25 wt. %, 20 wt. % or 15 wt. %.

### BRIEF DESCRIPTION OF THE DRAWINGS

FIG. 1 represents a first embodiment of a device according to the invention for carrying out the method according to the invention.

FIG. 2 represents a second embodiment of a device according to the invention for carrying out the method according to the invention.

FIG. 3 represents a third embodiment of a device according to the invention for carrying out the method according to the invention.

FIG. 4 represents a fourth embodiment of a device according to the invention for carrying out the method according to the invention.

FIG. 5 represents a fifth embodiment of a device according to the invention for carrying out the method according to the invention.

FIG. 6 represents a first embodiment of a microwave radiator unit according to the invention for use in the device according to the invention for carrying out the method according to the invention.

FIG. 7 represents a second embodiment of a microwave radiator unit according to the invention for use in the device according to the invention and for carrying out the method according to the invention.

### DESCRIPTION OF THE FIGURES

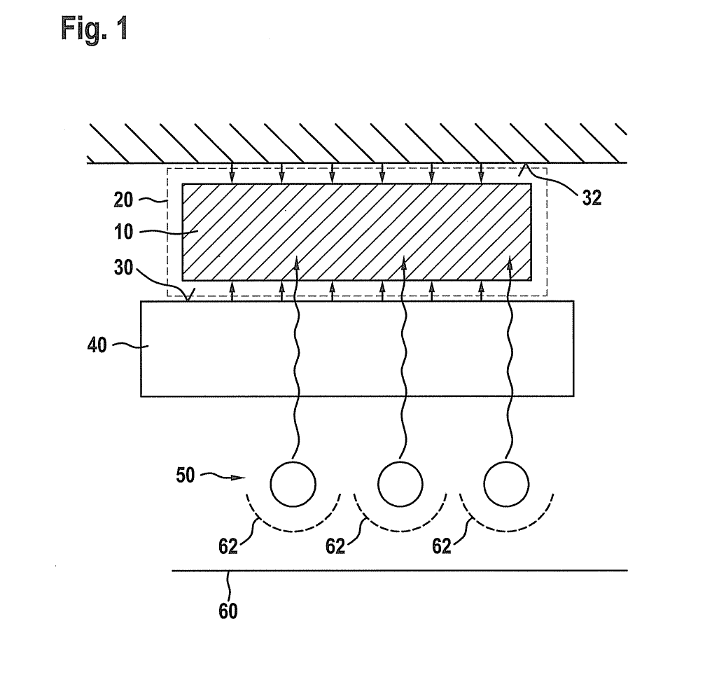

The first embodiment of the device according to the invention, represented in FIG. 1, is suitable for carrying out the method according to the invention. The device represented in FIG. 1 is used to prepare a basic structure of the invention. A shaped foam body 10 being processed, which is provided as a composition of foam particles and binder, is contained in a space 20 (represented by dashes) which is bounded on one side by a pressing surface 30. An opposite surface 32 is used in the same way as the pressing surface 30 exert pressure onto the foam body 10 being produced, so that the space is bounded by two sides which respectively exert pressure onto the foam body 10 being produced. The first embodiment, represented in cross section in FIG. 1, therefore provides a pressing surface 30 and an opposite counterbearing surface 32 which respectively exert pressure onto the shaped body 10 being produced between them, as indicated by the arrows distributed over the surface between the pressing surface 30 and the shaped foam body 10 and between the counterbearing surface 32 and the foam body 10. The gap represented in FIG. 1 between the composition 10 and the pressing surface 30 or the opposite surface 32 (i.e. counterbearing surface) serves only for illustration to represent the forces acting, and in real implementations does not exist. The pressing surface 30 is provided by a stiff layer 40, a side of the stiff layer 40 facing toward the space 20 providing the pressing surface 30. The surface of the stiff layer 40 facing toward the space 20 may be identical to the pressing surface 30, although in the embodiment represented in FIG. 1 it is larger than the pressing surface 30 and fully encloses it.

According to the invention a microwave radiator unit 50 is provided, which is arranged on the other side of the stiff layer 40 from the space 20 so that the stiff layer, which provides the pressing surface 30, is provided between the microwave radiator unit 50 and the space 20. The surface through which the microwaves (represented as arrows which pass through the layer 40) enter the space 20 therefore also exerts pressure simultaneously on the shaped foam body 10 being produced. The material which is provided between the pressing surface 30 and the microwave radiator unit 50 preferably comprises a structure and a material which are at least locally transparent for microwaves, and which are at the same time capable of delivering the pressure through the pressing surface onto the shaped foam body 10 being produced. The microwave radiator unit 50 represented in FIG. 1 comprises three rod antennas which are represented in cross section, although both the number and the type of antennas differ from that which is represented in FIG. 1. In FIG. 1, the microwave radiator unit 50 is furthermore equipped with reflectors 62 (represented by dashes) which are respectively allocated to an antenna and send the microwave radiation emitted uniformly by the rod antennas onto space 10. Instead of the reflectors (represented by dashes in FIG. 1) in the form of essentially semicircular or parabolic metal layers, the reflector 62 may also be provided by a simple plate 60 via which the microwave radiation, initially emitted by the antennas in a direction away from the space, is directed toward the space 20. The reflector 60 and the reflectors 62 may be provided as alternatives or in combination. Both the structure and the material of the reflectors 60 or 62 are preferably selected so that they reflect microwaves. This can be achieved by using conductive material such as metal and using a structure whose largest aperture is smaller, preferably much smaller than half the wavelength of the microwave radiation. For example, it is possible to use fine-meshed metal grids or continuous sheets which are either straight, cf. reflector 60, or respectively formed around a rod antenna and cover no more than one hemisphere, cf. reflectors 62. The reflectors are preferably aligned parallel to the rod antennas 50 and have a constant separation from the rod antennas of the microwave radiator unit 150 along a direction which is perpendicular to the plane of the drawing in FIG. 1a. When using horn radiators instead of rod antennas, neither a reflector 60 nor alternatively reflectors 62 are necessary since horn radiators already have a pronounced directional characteristic owing to their exit surfaces. The mutual separation of the antennas of the microwave radiator unit 50 and the separation from the space 20 are preferably selected so that an essentially homogeneous field strength distribution is obtained in the space 20, this being achievable in particular by the microwave radiator unit having a separation from the space 20 which is more than at least one wavelength of the microwave radiation. Near-field properties will therefore have minor effects on the field distribution in the space 20, and the individual directional bundles of the individual radiators of the microwave radiator unit furthermore intersect fully or at least partially inside the entire space or a majority of the space in order to achieve a high field strength homogeneity inside the space 20. Particularly in the case of radiators with a high directional effect, for example horn radiators, a separation between the pressing surface 30 or between the space 20 and the microwave radiator unit will be provided in order to avoid only particular sections inside the space 20 being heated strongly owing to the possibly narrow directional characteristic, while other sections receive only a low field strength.

The stiff layer 40 itself forms the pressing surface in the first embodiment as represented in FIG. 1, but force transmission is preferably provided between the stiff layer 40 in the pressing surface via an interlayer or further layers. The force transmission onto the pressing surface is provided by either the stiff layer 40, or the component which provides the bearing surface 32, being pressed toward the space 20. In FIG. 1, this may be achieved by the component, which forms the counterbearing surface 32, being exposed to a force in the direction of the space, for example by a weight force and/or a spring force, the stiff layer 40 simultaneously being held so that a pressure is set up between the two surfaces. The counterbearing surface 32, or the component which forms it, may furthermore be mounted at a fixed position with the stiff layer 40, which acts on the pressing surface 30, being pressed toward the space by force transmission. For example, spring elements may press the stiff surface 40 in the direction of the space. These alternatives may also be combined together, with one or more force-generating elements pressing together the stiff layer 40 and the component which forms the counterbearing 32. The composition between them, which provides the shaped foam body to be formed, therefore experiences a pressure which is combined with heating that is provided by the microwave radiator unit 50. The thermal irradiation and the pressurization are therefore provided in the same direction. The stiff layer 40 (or another component which exerts pressure onto the pressing surface 40) and the component which exerts the counterbearing surface 32, are preferably mounted for example via a force generation instrument which sets up the pressure represented in FIG. 1, the microwave radiator unit 50 and optionally the associated reflectors 62, 60 remaining free from the pressure application.

For the pressure generation, for example, a holding device may be provided which provides recesses for the radiators of the microwave radiator unit 50 (and optionally for the reflectors), and which prevents force transmission from the pressure surface, from the counterbearing surface, or from another element which is exposed to pressure, onto the radiator unit 50.

The microwave radiator unit 50 is represented with a rod antenna profile perpendicular to the plane of the drawing in FIG. 1. As an alternative, the rod antennas of the microwave radiator unit 50 may be provided parallel to the axis of the drawing and parallel to the pressing surface. In general, the microwave radiator unit will be formed parallel to the pressing surface. The rod antennas will thus be aligned parallel to the longitudinal axis of the webs such that the rod antennas are arranged in series parallel along the width of the web, preferably periodically, so that there is therefore in principle no restriction on the web width. In another embodiment, instead of using a line of rod antennas, it is possible to use a plurality of arrays arranged successively in the longitudinal direction of the web, each of which comprises rod antennas aligned mutually parallel which are provided along the web width. The foam bodies can thus be produced in the form of webs such as are used for example in the construction industry for insulation or for fire protection. The pressing surface therefore covers a region extending over the entire width of the web and along a certain length section of the web, the length of which is determined by the number of successively arranged arrays. A relatively large area can therefore be covered by the pressing surface and by the counterbearing surface, so that either the pressing surface 30 or the counterbearing surface 32, and preferably both of them have narrow grooves which extend along the width of the web (perpendicular to the plane of the drawing in FIG. 1) or along the web, through which water vapor formed can be removed without a pressure of being built up by vapor. Since the grooves can preferably be made relatively narrow, for example with a width of ≦2 cm, ≦1 cm, ≦5 mm, ≦2 mm or ≦1 mm, the pressing surface is interrupted only slightly so that an essentially homogeneous pressure is exerted onto the foam body 10 being produced despite the grooves provided by the channels. The channels are preferably aligned mutually parallel and have a mutual separation of at least x times the groove width with x≧1, 2, 5 or 10. The channels may in principle extend along any direction parallel to the pressing surface or parallel to the counterbearing surface 32, and they are preferably rectilinear. In principle, however, meandering channels may also be used. The channels are open toward the space 20 on a longitudinal channel side in order to receive the vapor from the space 20. They furthermore have at least one opening which does not lie in the pressing surface 30 or in the counterbearing surface 32, and which is connected hermetically to the surroundings.

If the composition contains water, then microwaves will be irradiated so that the composition is heated and a vapor pressure which is less than 500 mbar, less than 350 mbar, less than 300 mbar or less than 200 mbar is generated in it. The vapor pressure depends on the field intensity and the temperature. The maximum temperature is preferably ≦80° C., ≦70° C. or ≦65° C.

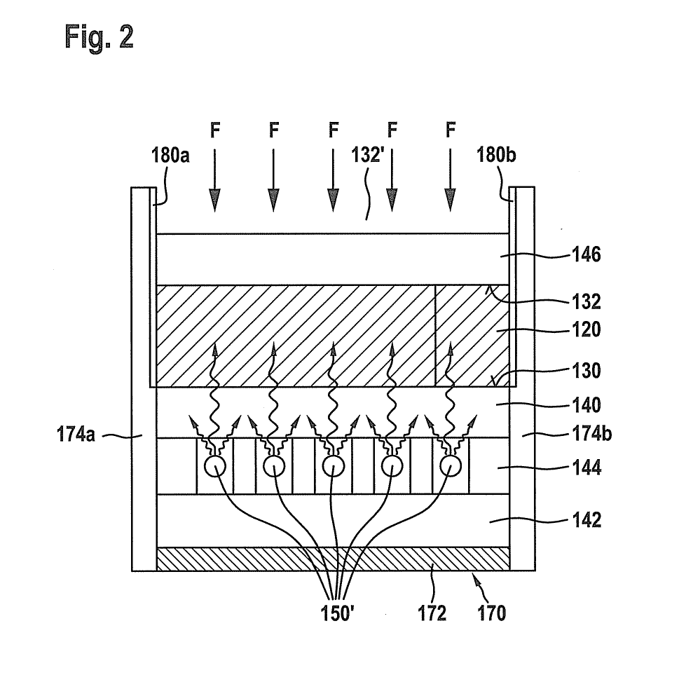

FIG. 2 represents a cross-sectional view of a second embodiment of the device according to the invention. The embodiment represented in FIG. 2 is suitable for batch operation, i.e. for individual manufacturing methods, in which the composition is initially applied and the foam body is fully formed from the composition before of the foam body is finally removed. The embodiment represented in FIG. 2 comprises a container 170, which provides outer walls of the device. Except for one side, the container or its outer walls fully enclose the space 120 and other components. The container 120 is open only on one side 132′. The container comprises a bottom 172, side walls 174a, b and side walls perpendicular thereto, which extend parallel to the plane of the drawing in FIG. 2. The container 120 thus forms an open-topped cube, or a cuboid which is open on the side 132′. The device furthermore comprises a bottom layer 142, a microwave radiator layer 144, a stiff layer 140 and a top layer 146, the space 120 being arranged between the top layer 146 and the stiff layer 140. The stiff layer 140 forms the pressing surface 130 through the side of the stiff layer 140 facing toward the space 120, and the top layer 146 forms the counterbearing surface 132 on a side of the stiff layer which faces toward the space 120. Elements of the microwave radiator unit are provided in the microwave radiator layer 144. The microwave radiator unit is provided by rod antennas 150′ (represented in cross section), which are provided in recesses of the microwave radiator layer 144. They are therefore relieved from the force provided by the pressure acting on the pressing surface. The recesses extend through the entire microwave radiator layer 144 and meet the neighboring layers 142 and 144.

The pressure exerted by the pressing surface 130 is generated by a force F which acts equally distributed over the top layer 146, and is therefore exerted via the space or the composition that it contains onto the pressing surface 130, which then returns the pressure in the direction of the space 120 as a reaction to this and owing to its mounting. The pressing surface 130 is held by the rigid layer 140, the microwave radiator layer 144 and by the layer 142 which directly adjoins the bottom 172 of the container. The force F may be provided by a weight force, which is generated by a plate that lies over the top layer 146. If it has a uniform thickness, then its weight force will be distributed uniformly over the space and therefore over the pressing surface 130. In this case, the counterbearing surface 132 delivers its force into the space in the same direction as that in which it is generated (compare the direction of the force F), while the pressing surface 130 exerts its force in the opposite direction according to the law of equal action and reaction. A force is therefore exerted actively by the counterbearing surface 132 in FIG. 2, while the force provided by the pressing surface 130 is produced in reaction to this. The terms “pressing surface” and “counterbearing surface” are therefore to be understood independently of the source of the force, and are not used to attribute the force generation to the pressing surface or the counterbearing surface. This will become clear in particular when describing embodiments in which microwaves are also emitted into the space through the counterbearing surface, so that it has essentially the same properties and effects as the pressing surface.

The inner sides of the side walls 174a, b have channels 180a, b, which are open toward the space and are formed across the top layer 146 in the inner side of the side walls 174a, b. Vapor which is formed can therefore pass from the space 120 through the channels 180a, b into the surroundings. For example, the vapor from a section of the composition represented on the right-hand side in FIG. 2 is discharged through the channel 180b represented on the right. In a particular embodiment of the device represented in FIG. 2, the pressing surface and the counterbearing surface 130, 132 also comprise channels, which extend along the surface in question and communicate with the channels 180a, b in the side walls 174a, b. The vapor emerging on the surface 130, 132 can therefore be discharged to the surroundings. Instead of or in combination with vapor, it is also possible to remove gases, for example air, which experience expansion owing to the heating. The channels 180a, b, and optionally the channels in the surface 130, 132, thus allow pressure equilibration in relation to the environment. In the embodiment represented in FIG. 2, the layers 146, 140, 144 and 142 are preferably configured so that they are transparent for microwaves. In this case, the bottom 172 of the container 170 forms a reflector for the microwave radiation which is emitted by the microwave radiator unit in the opposite direction from the space 120. Alternatively, the walls of the container 170 may be provided so that they are transparent for microwaves, for example all the side walls of the container or all the side walls except from the bottom plate 172 which is made of microwave-reflecting material, for example metal.

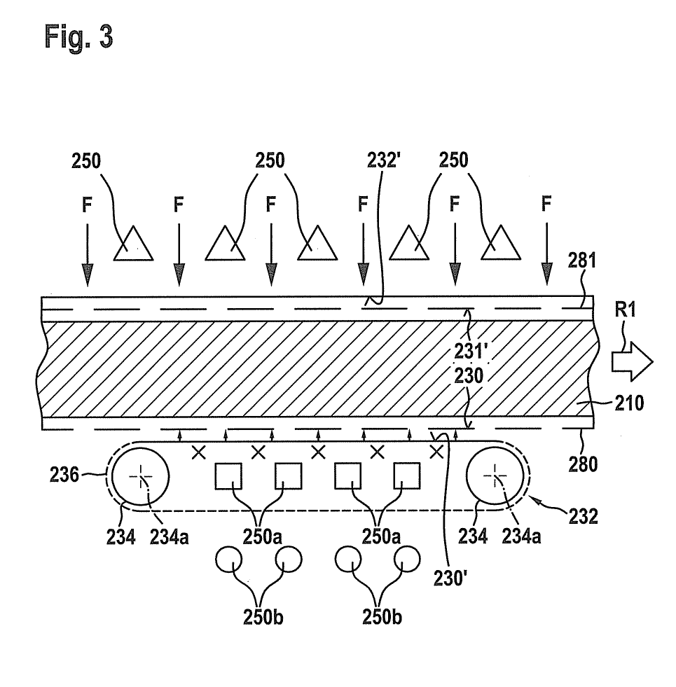

FIG. 3 represents a cross section of the 3^{rd} embodiment of the device according to the invention. In contrast to the device of FIG. 2 which is suitable for individual manufacture, the device represented in FIG. 3 is suitable for producing endless webs i.e. for continuous throughput operation. Feed belts are conventionally used in such devices in order to transport the foam body being produced or the composition. The transport direction is represented by R1. Below the space, the device comprises a conveyor belt 232 with rollers 234, which tension the endless belt 236. In FIG. 3, the endless belt is partially represented by dashes in order to emphasize the solid part as a pressure delivery surface 230′. The rollers 234 tauten the continuous endless belt 236 by the arrangement of their axles 234a, around which the rollers 234 execute a rotational movement. The tautening of the endless belt, particularly on the pressure delivery surface 230′, is generated by elastic properties of the belt and/or by sprung holding of the rollers 234 on the axles 234a, for example by means of a spring elements which press the axles away from one another. Instead of an endless belt, for example made of textile/plastic, a chain-link belt may in principle also be used, in which case at least one of the rollers 234 for feeding the chain-link belt may be designed as toothed wheels which engage into the chain-link belt. At least one of the rollers 234 in FIG. 3 is driven in order to generate movement in the direction R1.

The pressure delivery surface 230′ transmits the pressure (represented as arrows) onto an intermediate surface 280, which is used for physical separation of the pressure delivery surface 230′ from the shaped foam body 210 being produced. Particularly when using compositions which are still slightly tacky during production, or adhesive compositions, it is therefore possible to prevent sticking. To this end, nonstick materials are preferably used at least on the surface of the separating layer 280. The pressure delivery surface 230′ acts directly on the separating layer 280, which therefore provides the pressing surface 230 that directly adjoins the shaped foam body 210 being produced (i.e. the composition) and exerts pressure onto it. The pressure acting from the pressure delivery surface 230′ onto the separating belt 280 is represented by arrows in FIG. 3, which reflect a uniform pressure profile over the pressure delivery surface. The gaps between the pressure delivery surface 230 and the separating layer 280, or between the separating layer 280 and the shaped foam body 210 being produced, serve merely for illustration and in a real embodiment do not exist or are negligible. The separating layer 280 may likewise be fed by means of a conveyor belt mechanism and returned as an endless belt, for example via a cleaning station.

While the discussion above relates to a transport/pressure mechanism below the space, the following discussion essentially relates to a mechanism above the space, opposite the lower transport/pressure mechanism described above. A further (upper) separating layer 281 provides the counterbearing surface 231′, which directly adjoins the shaped foam body 210 being produced. The upper separating layer 281 may be designed like the separating layer 280, i.e. for example made of a flexible belt or textile which is used for physical separation of the shaped foam body from the processing surfaces. Like the (lower) separating layer 280, the (upper) separating layer 281 may be fed by means of a conveyor belt and configured as an endless belt. The embodiment of FIG. 3 furthermore comprises a counterbearing holder 232′ in the form of a surface extending parallel to the separating layer 232, in order to apply pressure to the counterbearing surface 231′. The pressure may be generated by a weight force or by a spring force or by means of hydraulics, the force thus generated being transmitted onto the surface of the counterbearing holder 232′. This leads to a uniform force distribution denoted by the force F, which acts on the counterbearing holder. The counterbearing holder may be provided by a plate which has a certain weight, or which is used to distribute a force acting on it.

According to one aspect of the embodiment represented in FIG. 3, it comprises a microwave radiator unit 250 which is arranged above the shaped foam body 210 being produced and whose individual antenna positions are represented as triangles, so that the (upper) separating layer 281 provides a pressing surface while the (lower) separating layer 280 provides a counterbearing surface. According to this aspect, the functions of the pressing surface and the counterbearing surface are interchanged relative to the device described above, this simple modification illustrating that the pressing surface and the counterbearing surface have the same function for the shaped foam body being produced, namely to compress it.

In the embodiment represented in FIG. 3, the counterbearing holder 232′ is arranged fixed so as to produce a relative movement of the separating layer 281 in the direction of advance R1. The separating layer 281 therefore slides while being guided by the surface of the counterbearing holder 232′. When a high pressure is applied, this may sometimes lead to a high adhesive fraction which would be reduced by using a glide layer between the separating layer 281 and the counterbearing holder 232′. As an alternative, the separating layer 281 may be provided, at least on the side facing toward the counterbearing holder, with a coating which reduces the adhesive fraction. The separating layer 281 (as well as the separating layer 280) may furthermore be provided with reinforcement which is used to absorb tension in the separating layer 281 (or 280) in the direction R1, in order to avoid significant deformation (extension) of the separating layer(s) in the event of sizeable sliding or adhesive friction between the separating layer(s) and underlying support layers.

According to a second aspect of the embodiment of FIG. 3, it comprises a microwave radiator unit 250a which is arranged on the side of the pressing surface and whose individual antenna positions are represented by squares. The microwave radiator unit 250a comprises a plurality of elements (in FIG. 3: four elements) which are provided inside the endless belt 236. The microwave rays of the microwave radiator unit therefore penetrate only through the pressure delivery surface, i.e. the upper section 230′ of the endless belt 232, and the separating layer 280, so as to be absorbed in the shaped foam body 210 being produced.

According to a third aspect of the embodiment of FIG. 3, it comprises a microwave radiator unit which is arranged below the entire endless belt 236 (i.e. the dashed and solid sections). This allows greater freedom in configuration, particularly in the case of microwave radiator units with a large design size. The microwave radiator units 250b radiate through the entire belt, i.e. the lower and upper sections of the revolving endless belt 236, and the separating layer 280, so as to be absorbed in the shaped foam body 210. The entire revolving feed belt 236 is made of a material which is transparent for microwaves.

In order to ensure a uniform, homogeneous and high pressure through the pressure delivery surface 230′, the belts 236 may be tensioned very tautly by means of the guide rollers 234. Rollers may furthermore be used for support, their positions being denoted by x in FIG. 3. These will be distributed along the revolving endless belt 236, directly below the pressure delivery surface, in order to support it. The rollers at the positions denoted by x have rotation axes which are parallel to the axles 234a. When using a microwave radiator unit according to the second and third aspects, i.e. a microwave radiator unit 250a or 250b as represented by a line of circles or a line of squares in FIG. 3, the support rollers provided at the positions x are preferably made of microwave-transparent material or have a structure which is essentially transparent for microwaves. For example, rollers whose rolling body consists of a microwave-transparent material may be used, the roller preferably also consisting of a microwave-transparent material or being provided in the form of a metal bar. In the event of a small diameter of the axles provided as metal bars, the emitted microwaves will be perturbed only insubstantially so long as the microwave radiator unit is distanced from these axles and the axial separation is much greater than one half wavelength or an even multiple of half a wavelength, so that in particular a homogeneous temperature distribution is provided for the shaped foam body since it is transported constantly in the direction R1. As a support, support rollers may thus be used which have a spacing so that their rollers made of metal do not represent a structure which blocks or reflects microwaves to a substantial extent.

While the radiator unit denoted by 250b (third aspect) is to be regarded as an alternative to the microwave radiator unit denoted by 250a, both alternatives may optionally be combined with a microwave radiator unit 250 (first aspect). If an embodiment of the invention as represented in FIG. 3 is equipped with a microwave radiator unit 250a, then an additional microwave radiator unit 250b will preferably not be used, and vice versa, although a microwave radiator unit 250 may optionally be combined with a microwave radiator unit 250a or 250b. When using a microwave radiator unit 250, it is important to note that no material which is not microwave-transparent should lie between it and the surface of the counterbearing holder, so that the counterbearing holder comprises a material and/or a structure which is transparent for microwaves, at least in the section between the microwave radiator unit 250 and the surface 232′.

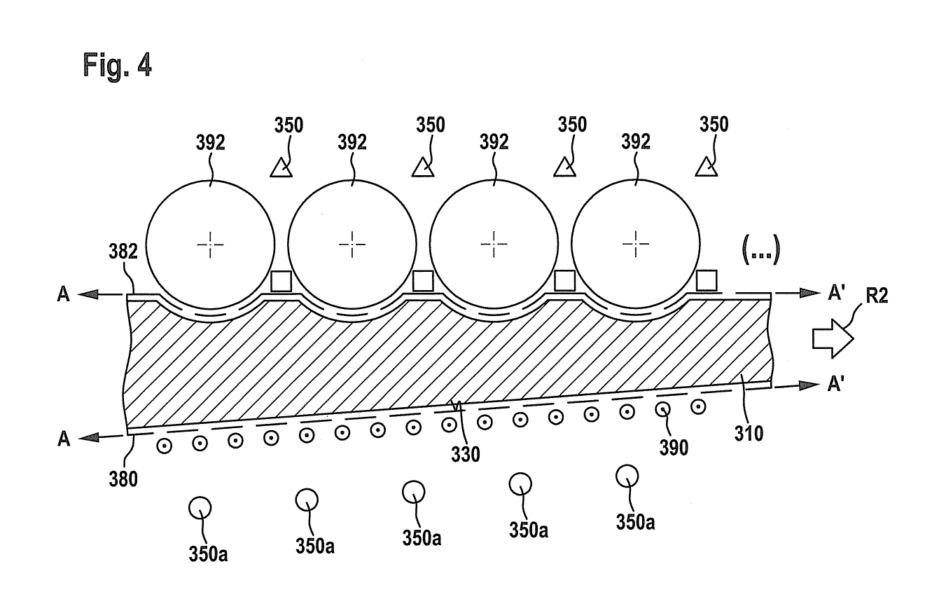

FIG. 4 shows a fourth embodiment of the device according to the invention for carrying out the method according to the invention, having an upper separating belt 382 and a lower separating belt 380 between which there is a space for the shaped foam body 310 being produced, i.e. for the composition to be processed. Both separating belts 380 and 382 are tautened, the arrows A and A′ indicating the tautening direction. The tautening is necessary so that the otherwise flexible belt can exert pressure onto the shaped body 310 being produced. The lower separating belt 380 is carried by a line of rollers 390 which, together with the tautening, provides the belt as a pressing surface 330 which exerts pressure onto the shaped body 310 being produced. The axles of the line of rollers 390 are preferably spaced apart uniformly, lie in a plane and are perpendicular to the transport direction R₂ of the shaped foam body 310 being produced. One embodiment (not shown) has another line of rollers like the line of rollers 390, which is formed on the upper separating layer in order to hold it.

The separating belt 328, and the pressure-exerting plane provided by the rollers, is inclined with respect to the plane which is inclined by the separating belt 380, the line of rollers 390 and by the recoil surface resulting therefrom. In the direction of advance R2, the space defined by these two planes tapers. The angle with which the two planes are mutually inclined, and thus the pressing surface is also inclined with respect to the opposite counterbearing surface, it is small and is preferably less than 10°, less than 5°, less than 2° or less than 1°. In one embodiment (not shown), which has the same features as FIG. 4 except for the inclination, the two opposing surfaces or planes are mutually parallel. The pressure results from the rollers 392 and 390, and also from the advance movement R2 when there is an inclination angle of more than 0°.

In FIG. 4, however, an alternative counterbearing device to this is provided on the upper side of the shaped foam body 310 being produced, which consists of rollers with a large cross section that are arranged almost directly in series. Owing to its arrangement near the shaped foam body being produced, the upper line of rollers 392 presses the separating layer 382, and therefore the shaped foam body 310 being produced, together with the pressing surface 330. The tautening of the upper separating layer 382 may be much less than the tautening of the lower separating surface 380, since the large diameter of the rollers 392 gives a large contact surface. The contact surface provided by the rollers 392, which is converted by the separating layer 382 into a counterbearing surface, is not plane but follows a part of the circumference of the rollers 392 in circular arcs. Owing to the large diameter, however, the force effects due to the rollers 392 on the shaped foam body 310 being produced is virtually planar and provides a sufficient pressure distribution.

According to a first aspect of the embodiment represented in FIG. 4, it comprises a microwave radiator unit 350 whose position is represented by triangles in FIG. 4, these being arranged above the rollers. The microwave radiator unit 350 therefore emits radiation which passes through the rollers 292. To this end, the rollers are preferably made of a material which is transparent for microwaves, although the rollers may also have a structure which allows microwaves to propagate through.

According to a second aspect of the invention, the microwave radiator unit is arranged at positions denoted by a square in FIG. 4, the radiators of which preferably radiate in the lower hemisphere into the shaped foam body and, owing to their arrangement, likewise heat the positions of the shaped foam body 310 being produced which lie below the rollers 392. Owing to the tautening of the separating layer 282, the elasticity of the foam body 310 being produced and the pressure through the rollers 392, the separating layer forms a pressing surface between the rollers 392 and below the radiators (squares). On the opposite side, i.e. on the side of the pressing surface 330, for example, a microwave reflector may furthermore be provided which sends back or reflects microwave rays which propagate through the shaped foam body 310 to the rollers 392, and therefore supplies microwave rays from the under side to the pressing surface provided by the rollers 392. In this way, microwaves are pressed through the pressing surface into the composition while pressure is exerted by the rollers 392 and the separating layer 382 onto the shaped foam body 310 being produced. The penetration depth of the rollers 392 depends on the pressure (of the rollers) and the elasticity (of the foam layer), and is not represented true to scale in FIG. 4.

According to a third aspect of the embodiment represented in FIG. 4, it comprises a radiator unit 350a whose position is represented by circles. Each of these circles may correspond to a radiator which introduces rays through the line of rollers 390 and through the pressing surface 330 into the shaped foam body 310 being produced. As in FIG. 3, the arrangement of the radiator unit 350a may be combined with the radiator unit 350 or with the radiator unit denoted by squares; an embodiment according to the invention preferably comprises either the radiator unit 350 or the radiator unit denoted by squares, but preferably not both. The radiator unit 350 is therefore freely combinable and optionally usable.

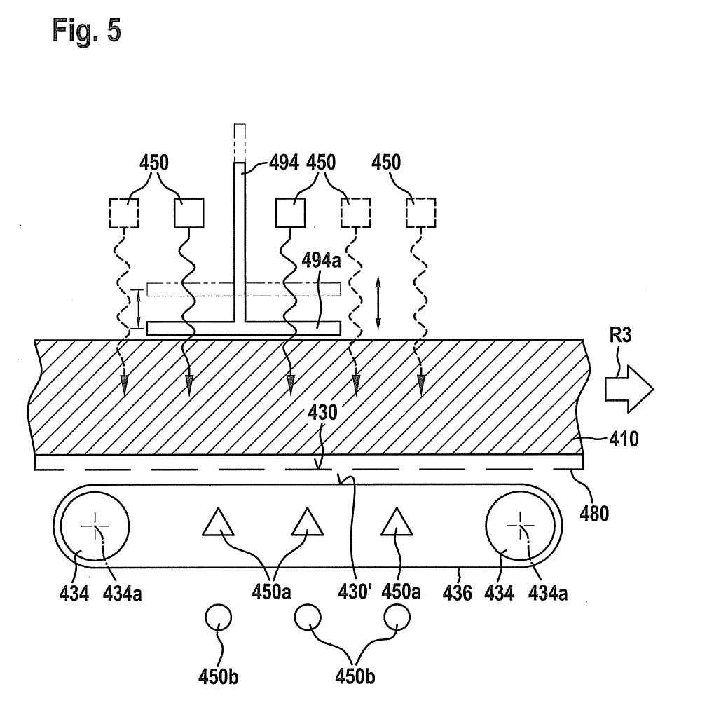

FIG. 5 represents a device for semicontinuous processing of the composition in order to produce shaped foam bodies. While the lower side of the shaped foam body 410 is fed in the direction R3 by the endless belt 436 and by the separating layer 480, which separates the shaped body 410 being formed from the feed belt 436, a periodically working plunger 494 is represented on the opposite side and instead of a continuous pressing device. The endless belt 436 is tautened by two rollers 434, which are held by respective axles 434a. As an alternative to or in combination with this, a line of rollers (not shown) may be provided between the rollers 434 in order to support the belt section 430′. The tautening is achieved by elasticity of the revolving belt 436 and/or by spring force, which presses the two rollers away from one another. The upper tautened part 430′ of the revolving belt 436 acts directly on the separating layer 480, which therefore provides the pressing surface 430 directly adjacent to the shaped foam body 410 being formed. The lower part of the embodiment represented in FIG. 5 therefore operates according to the embodiment represented in the lower part of FIG. 3 and may also be provided in the same way as it. The two feed belts operate continuously.

For active generation of the pressure, in FIG. 5 a plunger is used which presses onto the upper side of the shaped foam body 410, preferably via a separating layer (not shown). The plunger 434 is moved periodically up and down, the upper position being represented by dots and the lower position being represented by solid lines. In the lower position, the plunger 494 exerts pressure onto the shaped foam body 410 being produced, and in the upper position the plunger releases the shaped foam body 410 being produced so that the feed belt 436 moves the shaped foam body being produced in the direction R3 preferably only when the plunger 494 is not in the lower position, and the composition or the foam body is preferably advanced only when the plunger 494 is in the upper position. The stroke h of the plunger is less than the separation of a microwave radiator unit 450, which is arranged above the shaped foam body being produced. The microwave radiator unit comprises elements, represented solidly in FIG. 5, which are separated by the plunger from the shaped foam body 410 being produced. For this reason, the plunger surface 494a is made of microwave-transparent material. The elements of the microwave radiator unit which are represented by a solid line therefore irradiate the shaped foam body through the plunger surface 494a, so that the plunger surface 494a of the plunger 494 in the lower position exerts pressure onto the shaped foam body 410 being produced, while the elements of the microwave radiator unit 450 represented by a solid line introduce microwaves through the plunger surface 494a into the shaped foam body being produced. The microwave radiator unit 450 may comprise further elements which introduce microwaves through the plunger surface 494a into the shaped foam body 410 only as radiation inclined in the direction R₃. These elements are represented by dashes in FIG. 5. In FIG. 5, the arrows coming from the microwave radiator unit represent the direct path from the respective radiator units into the shaped foam body, although it should be noted here that the radiators of the microwave radiator unit 450 are not focused onto a direction but have a broad emission characteristic. The emission characteristic of the elements of the radiator unit, together with possible reflectors, is a half-space emission characteristic with an angle of at least 10°, 20° or 30° relating to −3 dB of the maximum. The radiation power in the direction inclined by 30° with respect to the principal ray direction is preferably not less than 30%, 40% or 60% of the power in the principal ray direction. This provides on the one hand homogeneous heating by the individual elements, and on the other hand a distribution of the emission energy by intersection of the individual emission characteristics.

In combination with or as an alternative to the microwave radiator unit 450, the embodiment of the invention as represented in FIG. 5 comprises a radiator unit 450a which is arranged inside the revolving belt 436. This radiates through the section of the belt 436 which is arranged directly on the pressing surface 430, and passes through the separating surface 480 so as to be absorbed in the shaped foam body 410 being produced. The microwave radiator unit 450a is comparable with the microwave radiator unit 250a of FIG. 3, and may have its properties. As an alternative to the microwave radiator unit 450a, but optionally combinable with the radiator unit 450, the embodiment represented in FIG. 5 comprises a microwave radiator unit 450b which irradiates through both sections of the revolving belt 336 and through the separating surface 480 into the shaped foam body 410 being produced. The microwave radiator unit 450b is comparable with the microwave radiator unit 250b of FIG. 3, and may have its properties. The gaps represented in FIG. 5 between the separating layer 480 and the endless belt 436, or between the separating layer 480 and the lower side of the foam body, are merely indicated for better presentation in FIG. 5 and in real implementations do not exist or are essentially negligible.

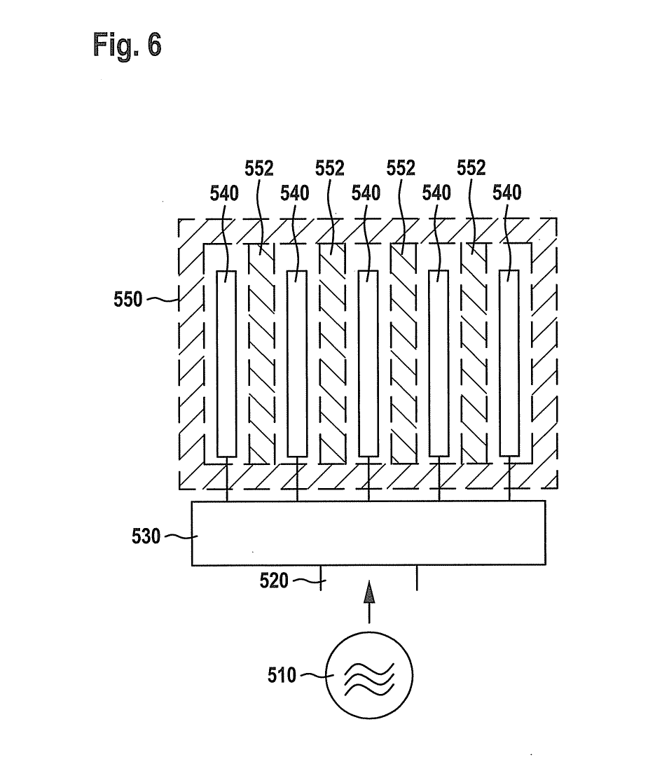

FIG. 6 represents a first embodiment of the microwave radiator unit according to the invention. It comprises a radiation source 510, which supplies an input 520 of a microwave distributor 530 with energy, cf. the arrow. The connection between the radiation source 510 and the microwave distributor 530 is preferably provided by a waveguide (not shown). The input 520 is preferably designed as a waveguide. The distributor 530 distributes the radiofrequency power delivered by the source 510 to rod antennas 540, which are arranged mutually parallel in an array. The distributor 530 therefore feeds all the rod antennas 540 from a common source 510. The rod antennas may be mutually aligned or mutually offset slightly along their longitudinal axes, so that their ends provide an alternating structure. The rod antennas 540 are fitted in a holding device 550 which comprises recesses, each recess receiving one rod antenna 540. Bars 552 are provided between the recesses, so that the holding device 550 can be pressurized in a direction perpendicular to the plane of the drawing. In particular, the bars keep the pressure away from the rod antennas 540 inside the holding device 550. Optional reflectors are not represented; they will extend along a plane in the plane of the drawing and parallel to the rod antennas. The reflectors may be provided as individual reflector elements, each rod antenna comprising a reflector element arranged parallel to it, which is arranged rotationally symmetrically with respect to the longitudinal axis of the rod antenna for an angle range or is shaped paraboloidally with the associated rod antenna inside the reflector focus. The reflector element is preferably likewise provided in the recesses, and protected from stresses. In particular, the rod antennas 540 are connected to the holding device 550 with a force fit (just as little as associated reflectors arranged there), so that it can keep any mechanical stresses isolated from the rod antennas. The holding device 550 is used to support the pressing surface or the counterbearing surface and transmit the pressure to them, but without exerting pressure onto the rod antennas or optionally associated reflectors.

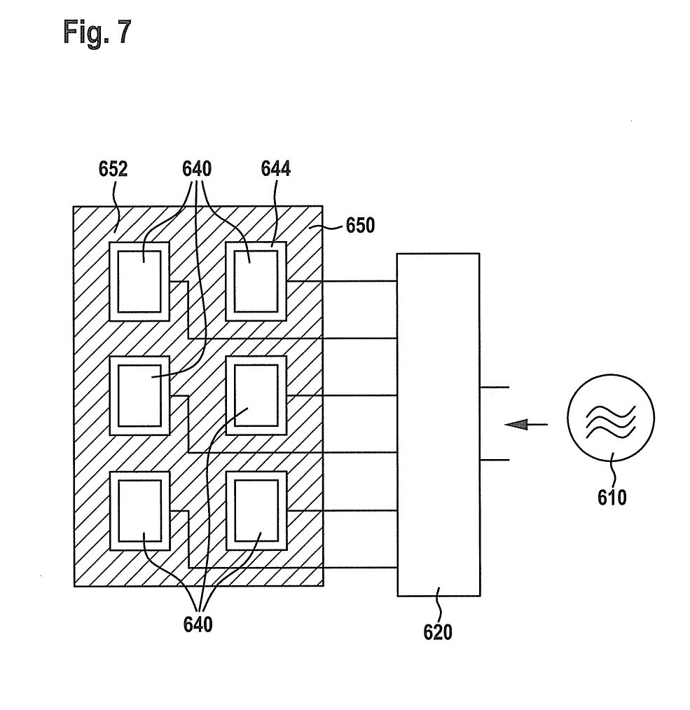

FIG. 7 shows a microwave radiator unit according to the invention according to a second embodiment of the invention. It comprises a microwave signal source 610, which is connected to a distributor 620. The connection (not represented in detail) of the source 610 to the distributor 620 is provided via a waveguide, through which microwave energy is transmitted to the distributor 620, cf. the arrow. The microwave distributor 620 distributes the power received from the signal source 610 to individual microwave radiator elements 640. The microwave power is distributed uniformly over all the radiator elements 640.

The radiator elements 640 are arranged in a two-line array, which may in principle also be configured as a single-line array (only the left-hand or right-hand column). Each line of the array comprises three radiator elements in the embodiment of FIG. 7, although an almost arbitrary number of radiator elements may be used. The radiator elements 640 are horn radiators, with a directional characteristic which is perpendicular to the plane of the drawing in FIG. 7 and radiates upward from the plane of the drawing. The horn radiators are arranged in recesses 644, in each of which there is exactly one horn radiator 640. The recesses 644 are formed by the holding device 650, which forms an outer frame, and bars 652 provided between the recesses 644. The bars 652 are formed between the individual horn radiators of a line, and between the lines. For the sake of clarity, in FIG. 7 only one such transverse bar provided and one such lengthwise bar 652 provided are denoted by references. FIG. 7 is not true to scale, the width of the bars corresponding to a fraction of the wavelength, for example less than one third, less than one fourth or less than one sixth of the wavelength. The bars, and the entire holding device 650 (i.e. including the outer frame) are preferably made of the same material, either in one part or several parts, in which case the material may be metal or plastic. The bars 652 and the outer frame of the holder 650 are used to provide a bearing, so that pressure can be transmitted mechanically to the pressing surface without a substantial proportion of the pressure being exerted onto the horn radiators 640. The output apertures of the horn radiators 640 lie in the same plane, the surface section of the holding device 650 which faces toward the pressing surface lying in this plane or preferably lying closer to the pressing surface with only a slight separation than the plane on which the exit apertures of the horn radiators 640 lie. This will ensure that no pressure is exerted onto the horn radiators 640, even in the event of slight deformation of the shaped body 640. The holding device may in principle be combined with any radiator elements and comprise an outer frame, bars or both.

The horn radiators are separated from one another by the bars 652, so that an inhomogeneous beam distribution is obtained in the immediate vicinity of the horn radiators. The inhomogeneous field distribution is essentially due to the emission characteristic of the individual horn radiators, and in particular results from the fact that no radiation naturally comes from the surface of the bars. The device of FIG. 7 is therefore preferably separated spatially from the pressing surface by a separating layer or spacer layer, so as to provide a spacing between the emission plane and the pressing surface. This will ensure that the emission characteristics of the individual horn radiators overlap at least partially. The bars 652 therefore do not provide blind spots in which no beam intensity, or only a low beam intensity, prevails at the level of the pressing surface. Rather, the separating layer or spacer layer allows the individual emission characteristics of the horn radiators to give a more or less homogeneous emission distribution for the pressing surface, and in particular for the space which contains the shaped foam body to be produced.

In principle, said microwave radiator unit may comprise the holding layer which is represented by way of example in FIGS. 6 and 7. The holding layer has recesses for the radiator units, and frames and preferably also bars by which pressure can be exerted indirectly or directly onto a pressing surface lying above. In this case, the distributor 620 is generally used for uniform distribution of the microwave energy and furthermore serves to determine the phase differences between the individual radiator elements. According to a preferred embodiment, besides a distributor conductor structure (preferably formed by micro-striplines or by waveguides), the distributor 620 also comprises an optional phase shift unit which varies the phase shift existing between the radiator elements over time. For example, the phase shift unit may provide 2 or more different phase shifts for the connected radiator elements, which change as a function of time, for example by switching. As an alternative, the phase shift unit may provide the phases between the individual radiator elements with a continuously varying phase offset. The function of phase shift unit, or the phase shift, for the space which contains the shaped foam body to be formed, is that the microwave energy prevailing there is distributed over time (and spatially) so that, for example, even when there spatial inhomogeneities these will be homogenized as a time average by means of the phase shift. This will give a more homogeneous temperature distribution or averaged field strength intensity inside the space.

In an alternative embodiment to FIGS. 6 and 7, the radiator elements are provided by patch antennas, i.e. by means of individual radiator surfaces which have a beam characteristic dependent on their geometry. Depending on their design, the radiator elements may be combined with a reflector which concentrates the directional characteristic onto the space. In this way even microwave rays which are not irradiated by the radiator unit per se into the space, which contains the shaped foam body, will be deflected toward it. In principle each radiator element, a group of radiator elements or all the radiator elements may have a reflector unit which is allocated to them.

### LIST OF REFERENCES

10, 110, 210, 310, 410 shaped foam body to be produced
20, 120 space, bounded by pressing surface
30, 130, 230, 330, 430 pressing surface
32, 132, 232′ counterbearing
230′ pressure surface for pressing surface
132′, 231′ pressure surface for counterbearing
40, 140, 280, 281, 380, separating layer
382, 480
142 bearing layer
144 radiator layer
146 bearing layer
434 conveyor belt roller bearings
434a roller axis
50, 150′, 250a,b, microwave radiator unit
350a, 450a,b, 540, 640
60, 62, 172 reflectors
170 container bottom
172, 174a, b container side walls
180,b channels
390 line of rollers
392 counterbearing rollers
494, 494a plunger, plunger surface
510, 610 microwave signal source
520 distributor input
530, 620 distributor
540, 640 microwave radiator elements
550, 650 holding device
552, 652 bars of the holding device
A, A′ extent direction of the separating surfaces
F pressing force
R1, R2, R3 feed direction of the shaped foam body being produced, or the composition

1-17. (canceled)

18. A method for the production of shaped foam bodies, comprising:
providing a composition having foam particles and binder;
introducing the composition into a space which is bounded on at least one side by a pressing surface; and
exerting pressure onto the composition by means of the pressing surface; wherein the method further comprises:
irradiating microwaves through the pressing surface into the composition, while pressure is being exerted onto the composition and wherein a ventilation medium, in particular environmental air or dried air, is directed through the space.

19. The method as claimed in claim 18, wherein the exertion of pressure comprises: pressing a stiff layer, which locally or entirely is essentially transparent for microwaves, against the composition inside the space, the stiff layer having a surface which faces toward the space, either with the surface of the stiff layer being provided by the pressing surface and directly adjoining the space, or with the surface of the stiff layer exerting pressure on an interlayer which is transparent for microwaves and is provided by the pressing surface that directly adjoins the space.

20. The method as claimed in claim 18, wherein the irradiation of microwaves is provided by irradiation of microwaves from outside the space through the pressing surface, at least a majority of the microwaves propagating through the pressing surface into the space.

21. The method as claimed in claim 18, wherein the irradiation of microwaves comprises: exciting a plurality of microwave antennas arranged flat and parallel to the pressing surface with a common radiofrequency microwave signal, which is guided via a distributor instrument from a radiofrequency source to at least two of the microwave antennas or to all the microwave antennas.

22. The method as claimed in claim 18, wherein the composition is at least partially fed continuously through the space by means of a conveyor belt and the pressure is exerted onto the composition continuously or with periodic repetition while the microwaves are being irradiated onto the composition located in the space, or, in an individual manufacturing method, the composition is initially introduced into the space, the composition introduced into the space is then exposed to the exertion of pressure and the irradiation of microwaves and finally the composition processed in this way is removed from the space.

23. The method as claimed in claim 18, wherein exerting a pressure onto the composition is carried out by movement of a counterbearing surface lying opposite the pressing surface, movement of the pressing surface, or movement of these two surfaces in the direction of the space, or by executing a movement of at least one roller and the composition relative to one another in a direction parallel to or inside the pressing surface, the at least one roller producing a roller pressing surface which extends lengthwise parallel to or inside the pressing surface and presses onto the composition.

24. The method as claimed in claim 18, wherein the composition is introduced into the space, which is bounded on each of two sides by mutually opposite pressing surfaces, between which the composition is provided; and
exerting pressure onto the composition by means of a plunger or rollers which are connected to the pressing surfaces in such a way as to transmit force; microwaves being irradiated through the two pressing surfaces into the composition while pressure is being exerted onto the composition by the two pressing surfaces.

25. The method as claimed in claim 18, which further comprises: the exerting pressure onto the composition for a period of time which immediately follows the irradiation of microwaves and which lasts until the composition has cooled at least by a predetermined minimum temperature difference after the irradiation of microwaves, or until the composition has set enough to have an essentially stable shape.

26. The method as claimed in claim 18, wherein the method is carried out in batch operation, wherein the composition is introduced into the space, which is fully enclosed except for one side, wherein the pressure is exerted in particular in a range of 10⁴-10⁶ Pa.

27. The method as claimed in claim 18, wherein the method is carried out in batch operation, wherein the composition is introduced into the space, which is fully enclosed except for one side, wherein the pressure is exerted in particular in a range of 5×10⁴-2×10⁵ Pa.

28. A device for pressing shaped foam bodies under the effect of heat, comprising:
at least one pressing surface and a counterbearing surface lying opposite, between which a space extends which is adapted to receive a composition of foam particles and binder, the pressing surface and counterbearing surface adjoining the space directly;
at least one stiff layer which locally or entirely is essentially transparent for microwaves and has a surface facing toward the space, which is connected to the pressing surface in such a way as to transmit force; and
a microwave radiator unit which is arranged on a side of the stiff layer remote from the space and is aligned relative to the space in order to irradiate microwaves into the space through the stiff layer, wherein the surface comprises a channel or a groove system allowing ventilation and removal of emerging water outward.

29. The device as claimed in claim 28, wherein either the surface facing toward the space comprises the pressing surface and the stiff layer adjoins the space directly via the surface facing toward the space, or the pressing surface is provided by a microwave-transparent interlayer which directly adjoins the space and is connected to the stiff layer in such a way as to transmit force.

30. The device as claimed in claim 28, which further comprises a conveyor belt which is adapted to feed the composition into the space, is essentially transparent for microwaves and extends between the microwave radiator unit and the space, either with the conveyor belt extending between the stiff layer and the space or with the conveyor belt extending between the microwave radiator unit and the stiff layer; and the device further comprises rollers along which the conveyor belt is fed and the rollers are connected to the pressing surface in such a way as to transmit force.

31. The device as claimed in claim 28, which further comprises a plunger that is mounted in order to execute a longitudinal movement with respect to the space and is connected to the counterbearing surface or the pressing surface in such a way as to transmit force.

32. The device as claimed in claim 28, comprising: a microwave radiator layer in which the microwave radiator unit is arranged, and a spacer layer which is arranged between the microwave radiator layer and the space and is essentially transparent for microwaves, with the spacer layer comprising the stiff layer or with the spacer layer being connected to the stiff layer in such a way as to transmit force; the spacer layer is removable from the microwave radiator layer.

33. The device as claimed in claim 28, wherein the device is suited for batch operation, the space being fully enclosed except for one side.

34. A microwave radiator unit for the heat treatment of foam compositions, comprising: a multiplicity of microwave antennas which are arranged in a plane array and at least two of which are connected through a distributor device to a common microwave signal source that feeds the at least two antennas.

35. The microwave radiator unit as claimed in claim 34, wherein the microwave antennas comprise horn radiators aligned in the same direction or rod antennas arranged mutually parallel.
